(19) United States
(12) Patent Application Publication
(10) Pub. No.: US 2021/0312372 A1
(43) Pub. Date: Oct. 7, 2021

(54) INFORMATION PROCESSING APPARATUS, INFORMATION PROCESSING METHOD, AND INFORMATION PROCESSING SYSTEM

(71) Applicant: SONY CORPORATION, TOKYO (JP)

(72) Inventor: TAKAHITO MIGITA, TOKYO (JP)

(21) Appl. No.: 17/250,497

(22) PCT Filed: Apr. 24, 2019
(86) PCT No.: PCT/JP2019/017377

§ 371 Date: Jan. 28, 2021

(30) Foreign Application Priority Data
Aug. 6, 2018 (JP) 2018-147854

(51) Int. Cl. G06Q 10/06; G06Q 10/08; B60R 25/01; B60R 25/20; B60P 3/00

(52) U.S. Cl. CPC G06Q 10/063114; G06Q 10/063118; G06Q 10/06398; G06Q 50/26; B60R 25/01; B60R 25/20; B60P 3/007; G06Q 10/08345

(57) ABSTRACT

An information processing apparatus (10) includes a selection unit (40D), a first open and close control unit (40H), and a second open and close control unit (40I). The selection unit (40D) selects at least one of a plurality of delivery persons as a person-in-charge of delivering a package based on delivery destination information and delivery person management information. Having received the delivery person input information of the person-in-charge, the first open and close control unit (40H) transmits a first switching instruction for switching a door (25) of a first accommodating unit (12A) from a locked state to an unlocked state, to the first accommodating unit (12A). When a package (22) is accommodated in the second accommodating unit (12B) installed on a delivery destination side and a second open and close control unit (40I) has received recipient input information of the recipient of the package (22), the second open and close control unit (40I) transmits a second switching instruction of switching the door (25) of the second accommodating unit (12B) from the locked state to the unlocked state, to the second accommodating unit (12B).

### FIELD

The present disclosure relates to an information processing apparatus, an information processing method, and an information processing system.

### BACKGROUND

Packages are delivered by delivery persons as general practices. For example, a package having a delivery request is delivered to a destination by a delivery person and delivered to a recipient. In addition, a system that authenticates the delivery person from the ID card to deposit the delivery item in a cabinet box that is unlocked by a key possessed by the delivery person, and a system that manages transportation from shipping to sale of an item by attaching a non-contact IC tag to the item are disclosed (for example, Patent Literatures 1 and 2).

### CITATION LIST

### Patent Literature

Patent Literature 1: JP 2017-174371 A

Patent Literature 2: JP 4552574 B2

### SUMMARY

### Technical Problem

However, in order to ensure the security of the package to be delivered, a limited delivery person with fidelity guarantee has been in charge of delivery in conventional operations. For this reason, there are cases where it is difficult to obtain an appropriate delivery person for delivering the package, leading to inefficient delivery. That is, it has been difficult to achieve both security assurance and delivery efficiency improvement in conventional operations.

Therefore, the present disclosure proposes an information processing apparatus, an information processing method, and an information processing system capable of achieving both security assurance and delivery efficiency improvement.

### Solution to Problem

To solve the problem described above, an information processing apparatus includes: a selection unit that selects at least one of a plurality of delivery persons as a person-in-charge of delivering a package based on delivery destination information regarding a delivery destination of the package and delivery person management information of the plurality of delivery persons; a first open and close control unit that, after having received delivery person input information of the person-in-charge, transmits a first switching instruction for switching a door of a first accommodating unit installed on a delivery source side and accommodating the package, from a locked state to an unlocked state, to the first accommodating unit; and a second open and close control unit that, after the package is accommodated in a second accommodating unit installed on a delivery destination side and after having received recipient input information of a recipient of the package, transmits a second switching instruction for switching a door of the second accommodating unit from a locked state to an unlocked state, to the second accommodating unit.

### Advantageous Effects of Invention

According to the present disclosure, it is possible to achieve both security assurance and delivery efficiency improvement. It should be noted that the effects described herein are not necessarily limited and may be any of the effects described in the present disclosure.

### BRIEF DESCRIPTION OF DRAWINGS

FIG. 1 is a schematic diagram illustrating an example of an information processing system according to an embodiment of the present disclosure.

FIG. 2 is a schematic view illustrating an example of a specific configuration of an accommodating unit according to an embodiment of the present disclosure.

FIG. 3 is a schematic diagram illustrating an example of a box according to an embodiment of the present disclosure.

FIG. 4A is a view illustrating an example of movement of a partition member according to an embodiment of the present disclosure.

FIG. 4B is a view illustrating an example of movement of a partition member according to an embodiment of the present disclosure.

FIG. 4C is a view illustrating an example of movement of a partition member according to an embodiment of the present disclosure.

FIG. 4D is a view illustrating an example of movement of a partition member according to an embodiment of the present disclosure.

FIG. 4E is a view illustrating an example of movement of a partition member according to an embodiment of the present disclosure.

FIG. 4F is a view illustrating an example of movement of a partition member according to an embodiment of the present disclosure.

FIG. 5 is a functional block diagram of an information processing apparatus, an accommodating unit, and a box according to an embodiment of the present disclosure.

FIG. 6 is a schematic diagram illustrating an example of a data structure of a delivery person DB, a requester DB, an accommodating unit DB, and a delivery management DB according to an embodiment of the present disclosure.

FIG. 7 is a sequence diagram illustrating an example of a procedure of a registration process according to an embodiment of the present disclosure.

FIG. 8 is a sequence diagram illustrating an example of a procedure of a deposit process according to an embodiment of the present disclosure.

FIG. 9 is a sequence diagram illustrating an example of a procedure of a delivery process according to an embodiment of the present disclosure.

FIG. 10 is a sequence diagram illustrating an example of a procedure of a reception process according to an embodiment of the present disclosure.

FIG. 11 is a hardware configuration diagram illustrating an example of a computer that actualizes functions of an information processing apparatus, an accommodating unit, a terminal device, and a box according to an embodiment of the present disclosure.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

[Configuration of Information Processing System According to Embodiment]

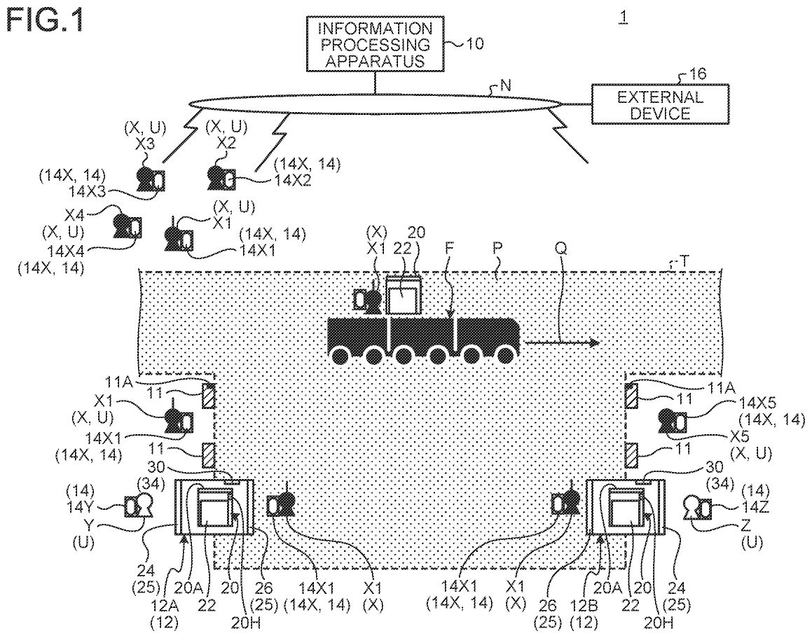

FIG. 1 is a schematic diagram illustrating an example of an information processing system 1 according to the present embodiment. The information processing system 1 is a system that manages the delivery of a package 22. The package 22 is an item to be delivered. The size and form of package 22 is not limited. Furthermore, the package 22 may be an animate or inanimate object.

The information processing system 1 includes an information processing apparatus 10, an accommodating unit 12, a terminal device 14, and an external device 16. The information processing apparatus 10, the accommodating unit 12, the terminal device 14, and the external device 16 are communicably connected by wireless or wired connection via a network N.

The information processing apparatus 10 is an apparatus that manages the information processing system 1. In the present embodiment, the information processing apparatus 10 manages the delivery of the package 22 by a user U.

In the present embodiment, the user U is classified into a requester Y, a delivery person X, and a recipient Z. The requester Y is the user U who requests the delivery of the package 22. The delivery person X is the user U as a candidate for a person in charge of delivering the package 22. The recipient Z is the user U who receives the package 22. The information processing apparatus 10 selects a person-in-charge X1 of the delivery of the package 22 from among delivery persons X (details will be described below). The person-in-charge X1 delivers the package 22 requested to be delivered to the recipient Z by the requester Y in a direction of a delivery destination of the package 22.

In the present embodiment, the person-in-charge X1 delivers the package 22 using public transportation F. Public transportation F is transportation shared by a plurality of users U. Specifically, the public transportation F is a transportation system that transports the user U and the package 22 permitted to use the service by paying a usage fee or the like. Examples of the public transportation F include a railroad, a bus, an airplane, a ferry, or the like. For example, the public transportation F is usable within a usable area P where public transportation F is usable.

The usable area P is predetermined according to the public transportation F. For example, the person-in-charge X1 can use the public transportation F by entering the usable area P through a gate 11 installed at a boundary T of the usable area P. In addition, the person-in-charge X1 exits from the usable area P through the gate 11. The boundary T is a boundary line between the inner and outer areas of the usable area P.

The gate 11 is the gateway to the usable area P of the public transportation F. The gate 11 includes a known mechanism for determining whether to allow the user U to enter the usable area P. The determination mechanism may be provided in the external device 16 or the information processing apparatus 10. For example, whether to permit entry to the usable area P by the user U passing through the gate 11 is to be determined by determining the detection signal of the gate 11 by the external device 16.

In the present embodiment, a mode in which the gate 11 includes a sensor 11A and an open and close mechanism will be described as an example. The sensor 11A permits the entry of the user U who satisfies predetermined entry permission conditions, to the usable area P. When the sensor 11A permits the entry, the sensor 11A switches the gate 11 from a closed state to an open state. The conditions for entry is to be determined in advance.

In the present embodiment, only the user U permitted to use the public transportation F by the sensor 11A or the like can enter the usable area P. That is, the usable area P is an area where public transportation F can be used, and is an area where security is ensured as compared with the area outside the usable area P. Therefore, in the present embodiment, the package 22 is delivered within the usable area P by the person-in-charge X1 who is permitted to enter the usable area P of the public transportation F.

The usable area P in the present disclosure is not limited to the area where entry is permitted only for the user U who is permitted to use the public transportation F by the gate 11. That is, the information processing system 1 need not include the gate 11. In addition, the public transportation F is not limited to an organization that can be used only within a specific area such as within the usable area P.

The accommodating unit 12 is a storage box for temporarily accommodating or storing the package 22. In the present embodiment, the package 22 is delivered from the requester Y to the recipient Z via the accommodating unit 12. The accommodating unit 12 is, for example, a locker, a box, a storage room, or the like. The accommodating unit 12 is pre-arranged at each of a plurality of points as a delivery destination of the package 22. In the present embodiment, a case where a plurality of accommodating units 12 is installed on the boundary T of the usable area P will be described. Furthermore, in the present embodiment, at least a part of the plurality of accommodating units 12 is arranged at mutually different points.

The accommodating unit 12 is equipped with a door 25. The door 25 can be switched between a locked state and an unlocked state. The accommodating unit 12 is further equipped with a control unit 30 and a communication unit 34. The accommodating unit 12 is communicably connected with the information processing apparatus 10 via the communication unit 34 and the network N.

The accommodating unit 12 is classified into a first accommodating unit 12A and a second accommodating unit 12B. The first accommodating unit 12A is an accommodating unit 12 arranged on the delivery source side of the package 22. The second accommodating unit 12B is an accommodating unit 12 installed on the delivery destination side of the package 22. Therefore, the accommodating unit 12 functions as the first accommodating unit 12A or the second accommodating unit 12B for each of the packages 22 to be delivered, depending on whether the accommodating unit 12 is located on the delivery source side or the delivery destination side of the package 22. When the first accommodating unit 12A and the second accommodating unit 12B are collectively described, they are simply referred to as the accommodating unit 12.

In the present embodiment, the package 22 is accommodated by the requester Y in the first accommodating unit 12A. The package 22 accommodated in the first accommodating unit 12A is handed over to the person-in-charge X1 who uses the public transportation F. The package 22 is delivered from the delivery source side to the delivery destination side within the usable area P the use of the public transportation F (refer to arrow Q) by the person-in-charge X1. The package 22 delivered by the person-in-charge X1 is accommodated in the second accommodating unit 12B. The package 22 accommodated in the second accommodating unit 12B is taken out by the recipient Z of the package 22.

The terminal device 14 is a device that can be carried by the user U who uses the information processing system 1. The terminal device 14 at least includes a communication function of communicating with other devices such as the information processing apparatus 10, an input function of receiving user's operation instructions, a display function of displaying various types of information, and a positioning function (global positioning system (GPS) function) of measuring the current position of the terminal device 14. The terminal device 14 is, for example, a tablet terminal or a smartphone.

As described above, in the present embodiment, the user U who uses the information processing system 1 is classified into the requester Y, the delivery person X, and the recipient Z. Therefore, the terminal device 14 is classified into a requester terminal device 14Y, a delivery person terminal device 14X, and a recipient terminal device 14Z. The requester terminal device 14Y is a terminal device 14 carried by the requester Y. The delivery person terminal device 14X is a terminal device 14 carried by the delivery person X. The recipient terminal device 14Z is a terminal device 14 carried by the recipient Z.

The external device 16 is a variety of server devices other than the information processing apparatus 10, connected to the network N. Examples of the external device 16 include: a server device that manages the operation of the public transportation F, the user who uses the public transportation F, or the like; and a server device that manages user's payment charges of a credit card or the like.

[Configuration of Accommodating Unit]

Next, a specific configuration example of the accommodating unit 12 will be described.

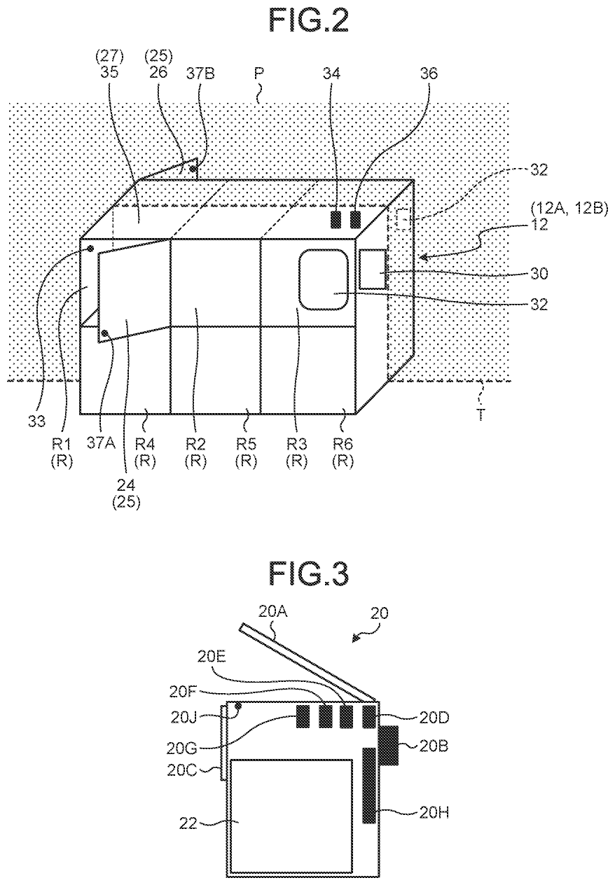

FIG. 2 is a schematic view illustrating a specific configuration example of the accommodating unit 12. The accommodating units 12 (first accommodating unit 12A and second accommodating unit 12B) are disposed across the boundary T of the usable area P. Furthermore, the accommodating unit 12 is equipped with the door 25. The door 25 is classified into an outer door 24 and an inner door 26. The outer door 24 is a door 25 that is openable and closable toward the outside of the usable area P. The inner door 26 is a door 25 that is openable and closable toward the inside of the usable area P.

The outer door 24 and the inner door 26 in the accommodating unit 12 are configured such that when one door 25 is in a locked state, the other door 25 is switchable from a locked state to an unlocked state.

The accommodating unit 12 is divided into a plurality of rooms R (for example, rooms R1 to R6). Each of the rooms R communicates with both the space inside the usable area P and the space outside the usable area P through the boundary T. Each of the rooms R has the inner door 26 on the usable area P side across the boundary T, while having the outer door 24 at an end on the opposite side of the usable area P (outside the usable area P).

Therefore, the accommodating unit 12 has a configuration in which the package 22 accommodated through the outer door 24 can be taken out from the inside of the usable area P across the boundary T through the inner door 26. Similarly, the accommodating unit 12 has a configuration in which the package 22 accommodated through the inner door 26 can be taken out from the outside of the usable area P across the boundary T through the outer door 24.

The number of rooms R provided in the accommodating unit 12 is not limited to six. The number of rooms R provided in the accommodating unit 12 may be one or more and less than five, or it may be seven or more.

The accommodating unit 12 includes a UI unit 32, a sensor 33, a communication unit 34, a transport drive unit 35, a communication unit 36, a lock and unlock unit 37A, a lock and unlock unit 37B, and a control unit 30. The control unit 30 is connected to the UI unit 32, the sensor 33, the communication unit 34, the transport drive unit 35, the communication unit 36, the lock and unlock unit 37A, and the lock and unlock unit 37B such that data and signals can be exchanged.

The UI unit 32 receives user's various operation inputs and performs output of various types of information. In the present embodiment, the UI unit 32 is provided individually on a usable area P-side end surface of the accommodating unit 12 and on an end surface of the accommodating unit 12 on the opposite side of the usable area P.

The UI unit 32 is, for example, a touch panel. The UI unit 32 may include an input function for receiving operation input and an output function for outputting various types of information, as separate members. Examples of the input function include a pointing device and an input button. Examples of the display function include an organic electro-luminescence (EL) or a liquid crystal display (LCD).

The sensor 33 detects the package 22 disposed in each of the rooms R. In the present embodiment, the sensor 33 is provided for each of the rooms R so as to detect the presence and absence of a box 20 in the room R and identification information of the box 20. Hereinafter, the identification information of the box 20 will be referred to as box ID. The communication unit 34 is a communication interface used to communicate with the information processing apparatus 10 and the terminal device 14 via the network N.

Inside the accommodating unit 12, a partition member 27 is provided along the boundary T. The partition member 27 is a member for partitioning an internal space and an external space of the usable area P in each of the rooms R in the accommodating unit 12. The partition member 27 can be switched between two states: a state where the two rooms are partitioned so as to prohibit the movement of the package 22; and a state where partition of these two spaces is removed so as to permit the movement of the package 22. The transport drive unit 35 controls the drive of the partition member 27.

The communication unit 36 is a communication interface that wirelessly communicates with the box 20 (refer to FIG. 1, which will be described in detail below) containing the package 22. The lock and unlock unit 37A switches the outer door 24 between the unlocked state and the locked state. The lock and unlock unit 37B switches the inner door 26 between the unlocked state and the locked state. The lock and unlock unit 37A switches the outer door 24 from the locked state to the unlocked state when the inner door 26 is in the locked state. A partition member 27B switches the inner door 26 from the locked state to the unlocked state when the outer door 24 is in the locked state.

[Box Configuration]

Next, a configuration example of the box 20 will be described.

FIG. 3 is a schematic view illustrating an example of the box 20. The box 20 is an accommodating member for accommodating the package 22. The box 20 is an accommodating member that can be switched between a locked state and an unlocked state. In the present embodiment, the package 22 is delivered in a state of being contained in the box 20, in the usable area P by the person-in-charge X1. Therefore, the accommodating unit 12 (first accommodating unit 12A, second accommodating unit 12B) accommodates the package 22 contained in the box 20 which can be switched between the locked state and the unlocked state.

The size of the box 20 is not limited. However, the box 20 may have a size enough to contain the package 22 inside and enough to be accommodated in each of the rooms R of the accommodating unit 12 (first accommodating unit 12A or second accommodating unit 12B). The box 20 may have a standardized size. Using the box 20 having a standardized size, the box 20 can be accommodated in the accommodating unit 12 installed at any place.

In the present embodiment, the box 20 has a lid 20A. The lid 20A can be switched from the unlocked state to the locked state, or from the locked state to the unlocked state.

Furthermore, the box 20 includes an imaging unit 20B, a display unit 20C, a GPS 20D, a scanner unit 20E, a speaker 20F, a communication unit 20G, a control unit 20H, and a lock and unlock unit 20J. The control unit 20H is connected with the imaging unit 20B, the display unit 20C, the GPS 20D, the scanner unit 20E, the speaker 20F, the communication unit 20G, and the lock and unlock unit 20J so as to be able to exchange data and signals.

The imaging unit 20B is an imaging device that obtains captured image data by imaging. Hereinafter, the captured image data will be described simply as a captured image. In the present embodiment, the imaging unit 20B is provided on an outer wall of the box 20. That is, the imaging unit 20B is arranged at a position capable of imaging external environment such as the user U holding the box 20. In the present embodiment, a case where the imaging unit 20B is disposed on the outer side wall of the box 20 will be described. The imaging unit 20B is a known digital camera.

The display unit 20C displays various types of information. The display unit 20C is a known organic EL or LCD. The display unit 20C is provided on the outer wall of the box 20. That is, the display unit 20C is arranged at a position that can be visually recognized by the user U who visually recognizes the box 20 from the outside. Therefore, the display unit 20C functions as an electronic label.

GPS 20D is a position measuring mechanism that measures the current position of the box 20. The scanner unit 20E detects the package 22 contained in the box 20. In the present embodiment, the scanner unit 20E has a function of detecting whether the package 22 has predetermined characteristics as a dangerous or hazardous item. For example, the scanner unit 20E is only required to include a known detection function of detecting specific radiation, a specific odor, a color or shape peculiar to a dangerous or hazardous item, or the like. The scanner unit 20E can be actualized by using a known device appropriate for the package 22 to be detected. The characteristics of the dangerous or hazardous items are to be determined in advance by a known method.

The speaker 20F is a mechanism for outputting sound. The communication unit 20G is a communication interface for wirelessly communicating with the accommodating unit 12 and communicating with the information processing apparatus 10 via the network N. The lock and unlock unit 20J switches the lid 20A between the unlocked state and the locked state.

The control unit 20H controls the imaging unit 20B, the display unit 20C, the GPS 20D, the scanner unit 20E, the speaker 20F, the communication unit 20G, and the lock and unlock unit 20J.

[Partition Member in the Accommodating Unit]

Next, the partition member 27 in the accommodating unit 12 will be specifically described. As described above, the partition member 27 is driven and controlled by the transport drive unit 35.

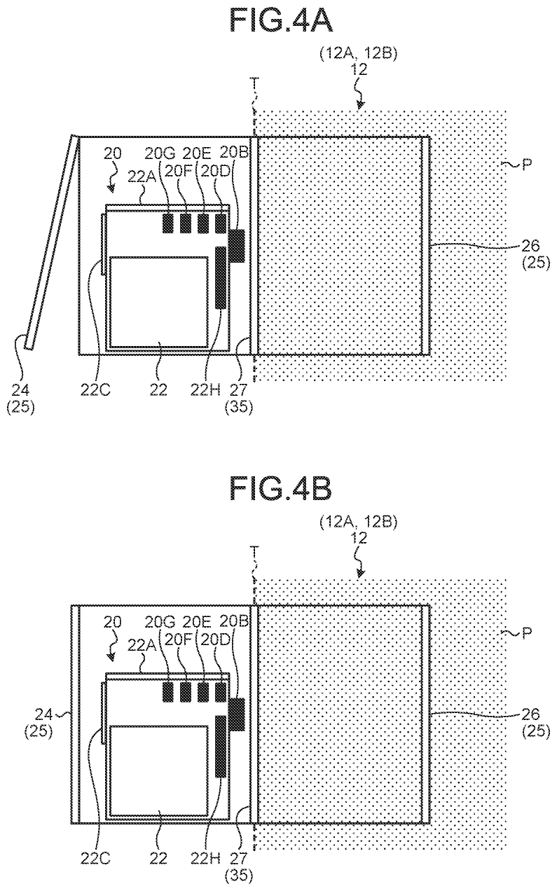

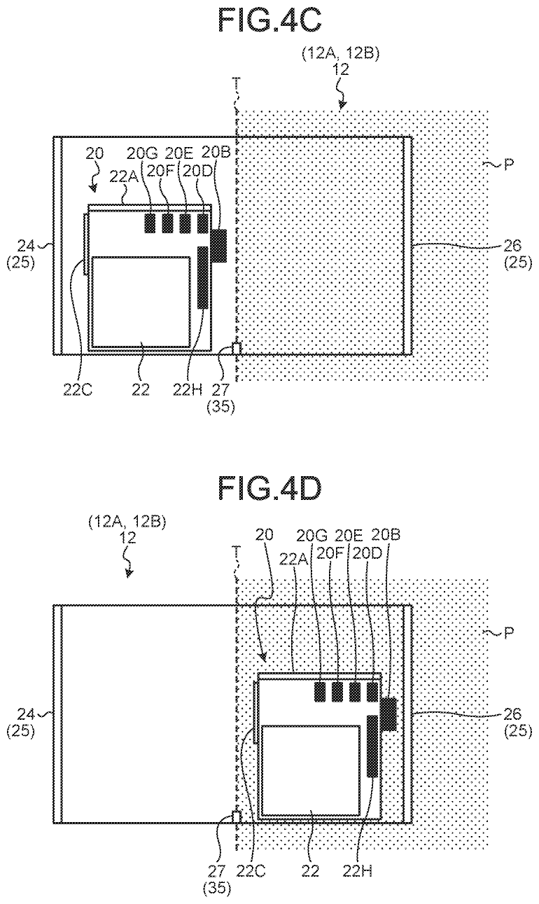

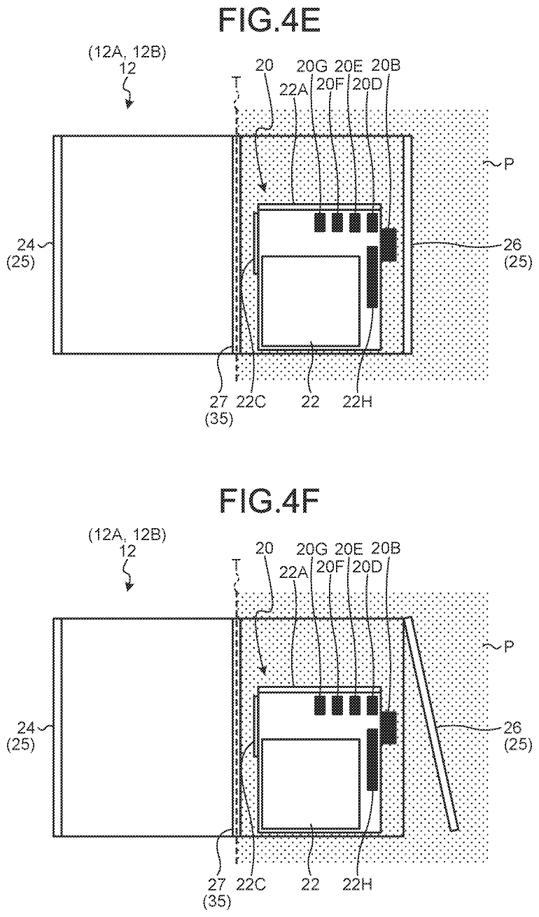

FIGS. 4A to 4F are views illustrating an example of the movement of the partition member 27. As an example, FIGS. 4A to 4F illustrate enlarged views of an internal portions of one of the rooms R. As described above, the partition member 27 is provided along the boundary T in each of the rooms R of the accommodating unit 12. The partition member 27 is, for example, a plate-shaped member having a two-dimensional plane along two axes in a direction along the boundary T and a vertical direction. The partition member 27 can use any member as long as being a member to partition the internal space of the usable area P and the external space of the usable area P in each of the rooms R of the accommodating unit 12 so as to prohibit movement of the package 22 via the boundary T, and is not limited to this configuration.

When at least one of the outer door 24 or the inner door 26 is in the unlocked state, the transport drive unit 35 drives the partition member 27 to be arranged at a position that partitions the above two spaces for each of the rooms R of the accommodating unit 12.

As illustrated in FIG. 4A, there is an assumable case where the lock and unlock unit 37A and the lock and unlock unit 37B control the outer door 24 to the unlocked state and the inner door 26 to the locked state. It is then assumed that the outer door 24 is opened and the box 20 is accommodated in the accommodating unit 12. The internal structure of the accommodating unit 12 is adjusted in advance so that the imaging unit 20B provided on the outer wall of the box 20 faces the inner door 26 side (usable area P side). In other words, the imaging unit 20B is arranged in the accommodating unit 12 so as to be able to image the inner door 26 side, that is, the inside of the usable area P.

For example, the bottom surface of each of the rooms R of the accommodating unit 12 has a recess having a shape that fits the shape of the bottom surface of the box 20. The shape of an edge portion of an outer peripheral edge of the bottom surface of the box 20 which is a boundary with a side wall where the imaging unit 20B is installed is different from the shape of the edge portion which is the boundary with the side wall where the imaging unit 20B is not installed. For example, the user U adjusts the direction of the box 20 so that the shape of the bottom of the box 20 and the recess of the bottom surface of the room R of the accommodating unit 12 match, and arranges the box 20 in the room R. With this arrangement, the box 20 is disposed in the accommodating unit 12 so that the imaging unit 20B of the box 20 faces the inner door 26 side (usable area P side).

Next, as illustrated in FIG. 4B, it is assumed that the outer door 24 is closed and in the locked state under the control of the lock and unlock unit 37A and the lock and unlock unit 37B. As illustrated in FIG. 4C, the transport drive unit 35 drives the partition member 27 so as to remove the partition. Accordingly, the partition using the partition member 27 is removed so that the box 20 can move from the space on the outer door 24 side in the room R to the space on the inner door 26 side via the boundary T. Subsequently, the transport drive unit 35 controls a transport mechanism such as a transport arm (not illustrated) to transport the box 20 located on the outer door 24 side to the space on the inner door 26 side via the boundary T (refer to FIG. 4D). The transport drive unit 35 then drives the partition member 27 so as to partition these spaces (refer to FIG. 4E). With these operations, the space on the outer door 24 side and the space on the inner door 26 side in the room R of the accommodating unit 12 are partitioned via the boundary T (partition member 27).

Subsequently, the lock and unlock unit 37A and the lock and unlock unit 37B switch the inner door 26 from the locked state to the unlocked state. It is then assumed that the inner door 26 is opened by the user U (refer to FIG. 4F). The user U can take out the box 20 through the inner door 26.

In this manner, when the box 20 is accommodated through the outer door 24, the space on the usable area P side and the space on the opposite side of the usable area P in the accommodating unit 12 are partitioned by the partition member 27 via the boundary T. Furthermore, when the box 20 is accommodated from the outer door 24 of the accommodating unit 12, the inner door 26 of the accommodating unit 12 is in the locked state.

Therefore, this leads to suppression of operation of taking out the box 20, which has been accommodated from the outer door 24 side, from the inner door 26 side (usable area P side) when the outer door 24 is in the unlocked state.

In addition, when the box 20 in the accommodating unit 12 is taken out through the inner door 26, the space on the usable area P side and the space on the opposite side of the usable area P in the accommodating unit 12 are partitioned by the partition member 27 via the boundary T. Furthermore, when the box 20 is taken out through the inner door 26 of the accommodating unit 12, the outer door 24 of the accommodating unit 12 is in the locked state.

Therefore, when the inner door 26 is in the unlocked state, operation of taking out the box 20 through the outer door 24 side (opposite side of the usable area P) will be suppressed.

In this manner, the accommodating unit 12 has a configuration capable of improving security when the box 20 is transferred across the boundary T of the usable area P.

Furthermore, the imaging unit 20B of the box 20 is disposed to enable imaging of the inner door 26 side (usable area P side). Therefore, the imaging unit 20B can image the person-in-charge X1 who opened an inner door 26B.

In a case where the box 20 is accommodated in the accommodating unit 12 through the inner door 26 and is taken out through the outer door 24, the transport drive unit 35 can perform drive control of the partition member 27 similarly to the above.

In this case, when the box 20 is accommodated through the inner door 26, the space on the usable area P side and the space on the opposite side of the usable area P in the accommodating unit 12 are partitioned by the partition member 27 via the boundary T. Furthermore, when the box 20 is accommodated through the inner door 26 of the accommodating unit 12, the outer door 24 of the accommodating unit 12 is in the locked state.

Therefore, this leads to suppression of taking the box 20 that has been accommodated from the inner door 26 side out from the outer door 24 side (usable area P side) when the inner door 26 is in the unlocked state.

In addition, when the box 20 in the accommodating unit 12 is taken out through the outer door 24, the space on the usable area P side and the space on the opposite side of the usable area P in the accommodating unit 12 are partitioned by the partition member 27 via the boundary T. Furthermore, when the box 20 is taken out from the outer door 24 of the accommodating unit 12, the inner door 26 of the accommodating unit 12 is in the locked state.

Therefore, when the outer door 24 is in the unlocked state, an operation of taking out the box 20 from the inner door 26 side (opposite side of the usable area P) will be suppressed.

[Functional Configuration of Information Processing System According to Present Embodiment]

Next, a functional configuration of the information processing system 1 according to the present embodiment will be described.

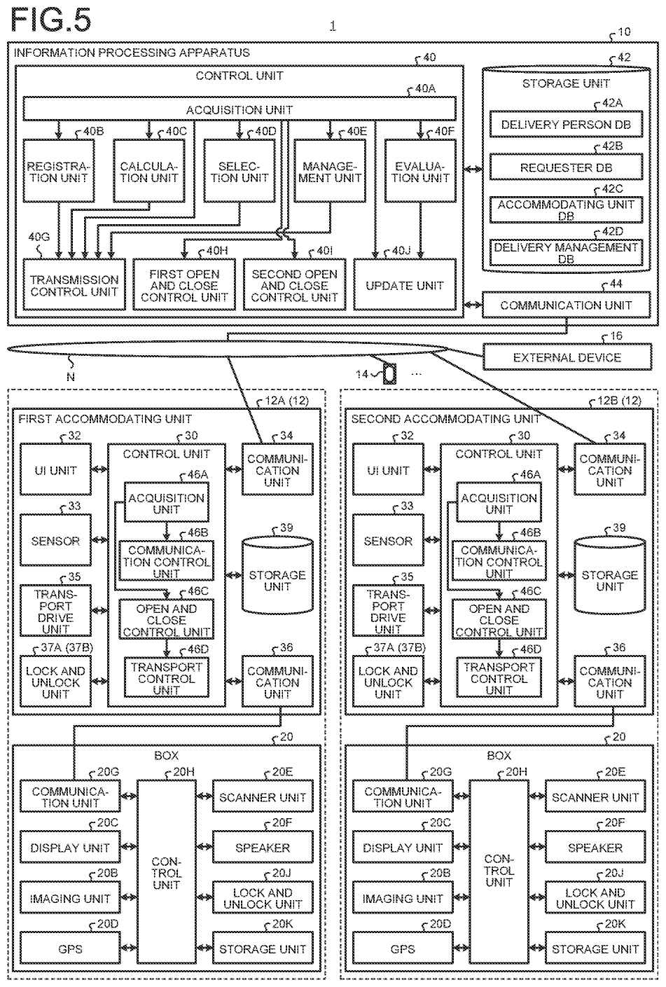

FIG. 5 is an example of a functional block diagram of the information processing apparatus 10, the accommodating unit 12, and the box 20.

[Configuration of Information Processing Apparatus According to Present Embodiment]

The information processing apparatus 10 includes a control unit 40, a storage unit 42, and a communication unit 44. The control unit 40, the storage unit 42, and the communication unit 44 are connected so as to be able to exchange data and signals.

The communication unit 44 is a communication interface that communicates individually with the terminal device 14, the accommodating units 12 (first accommodating unit 12A, the second accommodating unit 12B), and the external device 16 via the network N.

The storage unit 42 stores various types of data. The storage unit 42 stores, for example, a delivery person DB 42A, a requester DB 42B, an accommodating unit DB 42C, and a delivery management DB 42D.

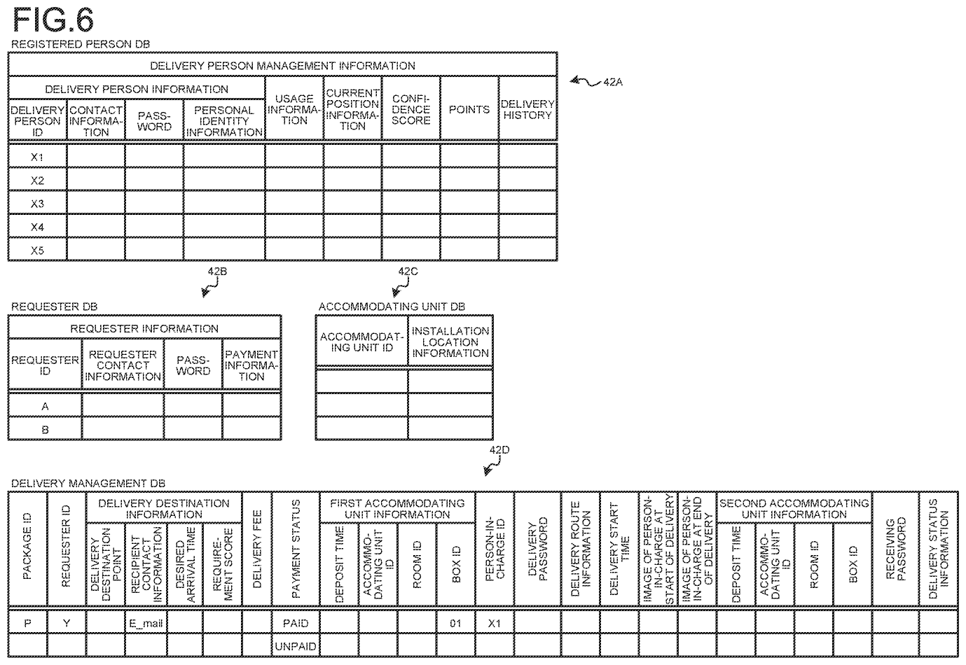

FIG. 6 is a schematic diagram illustrating an example of data structures of the delivery person DB 42A, the requester DB 42B, the accommodating unit DB 42C, and the delivery management DB 42D.

The delivery person DB 42A is a database that registers information regarding the delivery person X. The data format of the delivery person DB 42A is not limited to the form of database.

The delivery person DB 42A stores delivery person management information of each of the delivery persons X. The delivery person management information is information used for management of the delivery person X. The delivery person management information includes delivery person information, usage information, current position information, confidence score, points, and delivery history stored in association with each other.

The delivery person information is information from which the delivery person X can be identified. In the present embodiment, the delivery person information includes at least one of a delivery person ID, a delivery person contact information, a password, and personal identity information. The delivery person ID is the identification information of the delivery person X. The delivery person contact information is a communication address used when notifying the delivery person X of various types of information. The delivery person contact information includes, but is not limited to, the identification information of the delivery person terminal device 14X used by the delivery person X, e-mail address of the delivery person X, and the telephone number of the delivery person X, for example. The password of the delivery person DB 42A is a login password used when the delivery person X logs in to the information processing system 1. The personal identity information is detailed information regarding the delivery person X. Examples of the personal identity information include street address, name, bank account number of the delivery person X. The bank account number is used when paying the delivery fee to the delivery person X.

The usage information is information related to the use of the public transportation F by the delivery person X. Specifically, the usage information includes user's information such as personal information, information regarding the remaining payable amount of money stored in an electronic device or magnetic medium used at the time of utilizing the public transportation F, usage history information of the public transportation F, and usage route information indicating regular usage routes of the public transportation F.

The current location information is position information indicating the current position of the delivery person X.

The confidence score is information indicating the reliability of the delivery performed by the delivery person X. The higher the confidence score, the higher the reliability of delivery performed by the delivery person X. In other words, the higher the confidence score, the higher the delivery skill of the delivery person X.

The points are the points given to the delivery person X. The point is represented by electronic money or information that can be converted to electronic money.

The delivery history is information indicating a history of delivery of the package 22 performed by the delivery person X. For example, the delivery history includes the delivery date and time, the delivery destination, the identification information of the requester Y, identification information of the package 22, or the like.

The delivery person information in the delivery person DB 42A is registered in the delivery person DB 42A by a delivery person information registration process executed by the control unit 40. In addition, the usage information, the current position information, the confidence score, the points, and the delivery history in the delivery person DB 42A are updated by the control unit 40.

Next, the requester DB 42B will be described. The requester DB 42B is a database that registers information regarding the requester Y. The data format of the requester DB 42B is not limited to the form of database.

The requester DB 42B stores requester information of each of the requesters Y. The requester information is information used for managing the requester Y. The requester information is information including the requester ID, the requester contact information, the password, and payment information, stored in association with each other. The requester ID is the identification information of the requester Y. The requester contact information is a communication address used when notifying the requester Y of various types of information. The requester contact information includes, but is not limited to, the identification information of the requester terminal device 14Y used by the requester Y, the e-mail address of the requester Y, and the telephone number of the requester Y, for example. The password of the requester DB 42B is a login password used by the requester Y to log in to the information processing system 1. The payment information is information indicating the withdrawal source when the requester Y pays the delivery fee. Payment information is, for example, the bank account number of the requester Y.

The data of the requester DB 42B is stored and updated by the control unit 40.

Next, the accommodating unit DB 42C will be described. The accommodating unit DB 42C is a database for managing the accommodating unit 12. The data format of the accommodating unit DB 42C is not limited to the form of database.

The accommodating unit DB 42C is information including the accommodating unit ID and the installation location information stored in association with each other. The accommodating unit ID is identification information of the accommodating unit 12. The installation location information is information from which the installation location of the accommodating unit 12 can be identified. For example, the installation location information is information such as “next to B gate (gate 11) of A station” or “next to D gate (gate 11) of C station”.

The accommodating unit DB 42C is stored in the storage unit 42 in advance. The accommodating unit DB 42C may be updated under the control of the control unit 40 or the like when a new accommodating unit 12 is installed or when the installation position of the accommodating unit 12 is changed.

Next, the delivery management DB 42D will be described. Delivery management DB 42D is a database for managing the delivery of each of the packages 22. The data format of the delivery management DB 42D is not limited to the form of database.

The delivery management DB 42D is a database including a package ID, a requester ID, a delivery destination information, a delivery fee, a payment status, first accommodating unit information, person-in-charge ID, a delivery password, a delivery route information, delivery start time, an image of the person-in-charge at the start of delivery, an image of the person-in-charge at the end of delivery, second accommodating unit information, a receiving password, and the delivery status information, which are stored in association with each other.

The package ID is identification information for identifying the package 22. The requester ID is similar to the above.

The delivery destination information is information regarding the delivery address of the package 22 identified by the corresponding package ID. The delivery destination information includes at least one piece of information out of the delivery destination point of the package 22, the recipient contact information, desired arrival time, and a requirement score to the person-in-charge X1.

The delivery destination point is information indicating a delivery destination location of the package 22. The delivery destination location of the package 22 is represented by the place name or street address indicating the delivery destination of the package 22. The recipient contact information is a communication address used when notifying the recipient Z of various types of information. The recipient contact information includes, but not limited to the identification information of the recipient terminal device 14Z used by the recipient Z, e-mail address of the recipient Z, and the telephone number of the recipient Z, for example.

The desired arrival time indicates the arrival time, desired by the requester Y, at which the package 22 identified by the corresponding package ID can be delivered to the delivery destination. The requirement score indicates the score regarding the delivery skill that the requester Y requests from the person-in-charge X1 who is in charge of delivering the package 22. The higher the requirement score, the higher the requirement level for delivery skills. The requirement score and the above-described confidence score indicate scores (values) defined by the same criteria. Therefore, in a case where the value indicated by the requirement score and the value indicated by the confidence score are the same, the delivery skills are at the same level.

The delivery fee indicates the charge for delivery of the package 22 identified by the corresponding package ID. The payment status is information indicating whether the corresponding delivery fee has been paid or unpaid by the requester Y identified by the corresponding requester ID.

The first accommodating unit information is information regarding the first accommodating unit 12A which accommodates the package 22 to be delivered, installed on the delivery source side. Specifically, the first accommodating unit information includes the deposit time, the accommodating unit ID, the room ID, the box ID, or the like.

The deposit time is the time when the package 22 is accommodated in the first accommodating unit 12A. The accommodating unit ID is identification information of the first accommodating unit 12A. The room ID is the identification information of the room R in which the package 22 is accommodated. The box ID is identification information of the box 20 containing the package 22.

The person-in-charge ID is identification information of the person-in-charge X1 of delivery among the delivery persons. The delivery password is a password that is temporarily assigned to the person-in-charge X1 when the package 22 is delivered. For example, the delivery password is valid for the period from notification of the delivery password to the person-in-charge X1 until the package 22 identified by the corresponding package ID is accommodated in the second accommodating unit 12B of the delivery destination. The delivery password is issued by the control unit 40.

The delivery route information is information indicating the delivery route of the package 22 identified by the corresponding package ID. For example, the delivery route is represented by information such as “from station A to station C via station S”.

The delivery start time indicates the date and time when the delivery of the package 22 identified by the corresponding package ID is started. The person-in-charge image at the start of delivery is an image of the person-in-charge X1 captured by the imaging unit 20B at the start of delivery. The person-in-charge image at the end of delivery is an image of the person-in-charge X1 captured by the imaging unit 20B at the end of delivery.

The second accommodating unit information is information regarding the second accommodating unit 12B which accommodates the delivered package 22, installed on the delivery destination side. Specifically, the second accommodating unit information includes the deposit time, the accommodating unit ID, the room ID, the box ID, or the like. The deposit time included in the second accommodating unit information is the time when the package 22 is accommodated in the second accommodating unit 12B. The accommodating unit ID of the second accommodating unit information is the identification information of the second accommodating unit 12B. The room ID included in the second accommodating unit information is the identification information of the room R in which the package 22 has been accommodated, in the second accommodating unit 12B. The box ID of the second accommodating unit information is the identification information of the box 20 containing the package 22.

The receiving password is a password temporarily assigned to the recipient Z when the package 22 is delivered. For example, the receiving password is valid for the period from the notification of the receiving password to the recipient Z until the package 22 identified by the corresponding package ID is received by the recipient Z from the second accommodating unit 12B. The receiving password is issued by the control unit 40.

The delivery status information is information indicating the delivery status of the package 22. Specifically, the delivery status information includes: information indicating whether the package 22 has been delivered along the delivery route illustrated in the corresponding delivery route information; information indicating the actual delivery route of the package 22, and information indicating whether the package 22 has been accommodated in the second accommodating unit 12B before the desired arrival time, information indicating whether the person-in-charge X1 is away from the box 20 by a predetermined distance or more during delivery, or information indicating whether the images of the person-in-charge at the start and end of delivery are captured images of the same person-in-charge X1.

Each of pieces of information registered in the delivery management DB 42D is registered and updated by the control unit 40 described below.

The data structure of the data stored in the storage unit 42 is not limited to the above-described structures formed with the delivery person DB 42A, the requester DB 42B, the accommodating unit DB 42C, and the delivery management DB 42D. For example, at least a part of the delivery person DB 42A, the requester DB 42B, the accommodating unit DB 42C, or the delivery management DB 42D may be integrated as one database (DB). In addition, these databases may further contain other information.

Returning to FIG. 5, and description will continue. Next, the control unit 40 of the information processing apparatus 10 will be described.

The control unit 40 controls the information processing apparatus 10. The control unit 40 includes an acquisition unit 40A, a registration unit 40B, a calculation unit 40C, a selection unit 40D, a management unit 40E, an evaluation unit 40F, a transmission control unit 40G, a first open and close control unit 40H, a second open and close control unit 40I, and an update unit 40J. The entire or part of the acquisition unit 40A, the registration unit 40B, the calculation unit 40C, the selection unit 40D, the management unit 40E, the evaluation unit 40F, the transmission control unit 40G, the first open and close control unit 40H, the second open and close control unit 40I, and the update unit 40J can be actualized by execution of a program by a processing device such as a CPU, that is, by software, or by hardware such as an integrated circuit (IC), or even by a combination of software and hardware.

The acquisition unit 40A acquires various types of information from the accommodating unit 12 and the terminal device 14 via the communication unit 44 and the network N. For example, the acquisition unit 40A acquires the delivery person information and the current position information from the delivery person terminal device 14X of the delivery person X. The acquisition unit 40A further acquires the requester information and the delivery destination information, from the requester terminal device 14Y of the requester Y. In addition, the acquisition unit 40A acquires various types of information such as the first accommodating unit information, the delivery person input information, and the person-in-charge image from the first accommodating unit 12A. Furthermore, the acquisition unit 40A acquires various types of information such as the second accommodating unit information, the delivery person input information, the person-in-charge image, and the recipient input information, from the second accommodating unit 12B.

Furthermore, the acquisition unit 40A acquires the current position information from the box 20. Details of the delivery person input information and the recipient input information will be described below.

In addition, the acquisition unit 40A acquires a detection result regarding the person-in-charge X1. The detection result is information indicating a detection result regarding the person-in-charge X1 who is delivering the package 22. Examples of the detection result include a time-series set of position information of the person-in-charge X1, an image of the person-in-charge of the person-in-charge X1, or the like. The acquisition unit 40A acquires a time-series set of position information of the person-in-charge X1 from a person-in-charge terminal device 14X1 or the first accommodating unit 12A. The person-in-charge terminal device 14X1 is a terminal device 14 carried by the person-in-charge X1 among the delivery person terminal devices 14X.

For example, the acquisition unit 40A acquires the position information of the delivery person terminal device 14X detected by the GPS function provided in the person-in-charge terminal device 14X1, as the position information of the person-in-charge X1. For example, the acquisition unit 40A further acquires the position information of the box 20 delivered by the person-in-charge X1 and detected by the GPS 20D of the box 20, as the position information of the person-in-charge X1.

Furthermore, for example, the acquisition unit 40A acquires the image of the person-in-charge X1 captured by the imaging unit 20B of the box 20, from the first accommodating unit 12A and the second accommodating unit 12B.

Next, the registration unit 40B will be described. The registration unit 40B registers various types of information acquired by the acquisition unit 40A in each of databases (DBs) of the storage unit 42.

Specifically, the registration unit 40B registers the delivery person information acquired from the delivery person terminal device 14X by the acquisition unit 40A, to the delivery person DB 42A (refer to FIG. 6). Therefore, the delivery person information of the delivery person X, which is a candidate for the person in charge of the delivery of the package 22, is sequentially registered to the delivery person DB 42A.

In addition, the registration unit 40B registers the requester information acquired from the requester terminal device 14Y by the acquisition unit 40A, to the requester DB 42B (refer to FIG. 6). Accordingly, the requester information of the requester Y who requests the delivery of the package 22 is sequentially registered to the requester DB 42B.

In addition, the registration unit 40B registers the delivery destination information acquired from the requester terminal device 14Y by the acquisition unit 40A, to the delivery management DB 42D (refer to FIG. 6). At this time, the registration unit 40B assigns a package ID that uniquely identifies the package 22, and registers the acquired delivery destination information to the delivery management DB 42D by associating the package ID with the requester ID of the requester Y who requested the delivery of the package 22. With this registration, the delivery destination information is registered to the delivery management DB 42D in association with the package ID of the new package 22 and the requester ID every time the delivery request for the new package 22 is made.

In addition, the registration unit 40B registers the information of the first accommodating unit acquired from the first accommodating unit 12A by the acquisition unit 40A, to the delivery management DB 42D. In addition, the registration unit 40B registers the information of the second accommodating unit acquired from the second accommodating unit 12B by the acquisition unit 40A, to the delivery management DB 42D.

Next, the calculation unit 40C will be described. The calculation unit 40C calculates the delivery fee of the package 22 based on the delivery destination information acquired by the acquisition unit 40A. For example, the acquisition unit 40A calculates the delivery fee by using at least one of the delivery destination, the desired arrival time, or the requirement score included in the delivery destination information, and using a predetermined charge calculation function. Specifically, the longer the distance from the delivery source to the delivery destination included in the delivery destination information, or the shorter the time taken from the timing of acquisition of the delivery destination information to the desired arrival time included in the delivery destination information, or the higher the requirement score included in the delivery destination information, then, the higher the delivery fee calculated by the acquisition unit 40A will be. Subsequently, the calculation unit 40C registers the calculation result to the delivery management DB 42D in association with the package ID of the package 22 (refer to FIG. 6).

The delivery fee information indicating the delivery fee calculated by the calculation unit 40C is transmitted by the transmission control unit 40G to the requester terminal device 14Y of the requester Y identified by the requester ID corresponding to the delivery fee. The transmission control unit 40G identifies, from among the requester DB 42B, requester contact information corresponding to the requester ID corresponding to the calculated delivery fee in the delivery management DB 42D (refer to FIG. 6). The calculation unit 40C preferably uses this processing to identify the requester contact information of the requester Y, and the transmission control unit 40G is to transmit the delivery fee information to the requester contact information (for example, the e-mail address of the requester terminal device 14Y) indicated in the requester contact information.

Next, the selection unit 40D will be described. The selection unit 40D selects at least one of the plurality of delivery persons X as the person-in-charge X1 of the package 22 based on the delivery destination information and the delivery person management information of the plurality of delivery persons X. In the present embodiment, the selection unit 40D selects the person-in-charge X1 most suitable for the delivery of the package 22 by using the installation location of the first accommodating unit 12A in which the package 22 to be delivered is stored, requirements for the delivery of the package 22 indicated in the delivery destination information, and the delivery skill of the delivery person X indicated in the delivery person management information or the current situation of the delivery person X.

As described above, the delivery destination information includes the desired arrival time and the requirement score for the person-in-charge X1 (refer to FIG. 6). In addition, the delivery person management information includes the current position information of the delivery person X and the confidence score indicating the reliability of the delivery person X.

Therefore, in the present embodiment, the selection unit 40D selects the delivery person X located within a predetermined range from the first accommodating unit 12A and having a confidence score being the requirement score or above, as the person-in-charge X1, based on the desired arrival time and requirement score included in the delivery destination information, the installation location information of the first accommodating unit 12A accommodating the package 22, and the delivery person management information.

For example, as illustrated in FIG. 6, it is assumed that the delivery person management information of each of the plurality of delivery persons X (X1 to X5) is registered in the delivery person DB 42A. In addition, as illustrated in FIG. 1, the position of the person-in-charge X1 is assumed to be closest to the position of the first accommodating unit 12A installed on the delivery source side of the package 22, and the confidence score of the person-in-charge X1 is assumed to be the requirement score indicated in the delivery destination information, or higher. In this case, the selection unit 40D selects the person-in-charge X1 from among the plurality of delivery persons X (X1 to X5).

Note that the delivery person information may include information indicating an acceptable charge range for the delivery person X. In this case, the selection unit 40D may calculate the charge to be paid to the delivery person X from the delivery fee of the package 22, and may select the person-in-charge X1 using the delivery person information indicating the charge range, similarly to the above.

Subsequently, the selection unit 40D registers the delivery person ID of the selected person-in-charge X1 to the delivery management DB 42D as the person-in-charge ID of the package 22 (refer to FIG. 6).

Returning to FIG. 5, and description will continue. Next, the transmission control unit 40G will be described. The transmission control unit 40G performs control of transmitting various types of information individually to the external device 16, the terminal device 14, the accommodating units 12 (first accommodating unit 12A, the second accommodating unit 12B), and the box 20 via the communication unit 44 and the network N.

In the present embodiment, the transmission control unit 40G transmits delivery request information based on the delivery destination information, to the terminal device 14 of the person-in-charge X1 (person-in-charge terminal device 14X1).

Specifically, the transmission control unit 40G transmits a person-in-charge determination notification containing delivery request information, to the delivery person terminal device 14X of the person-in-charge X1 selected by the selection unit 40D. The person-in-charge determination notification is information indicating that the person-in-charge X1 has been selected.

The delivery request information is information indicating that a delivery of the package 22 will be requested to the person-in-charge X1. Specifically, the delivery request information includes a delivery destination point, a desired arrival time, installation location information of the first accommodating unit 12A in which the package 22 is accommodated, and a delivery password.

At the time of selecting the person-in-charge X1, the selection unit 40D is only required to issue a delivery password for the person-in-charge X1 and register the password to the delivery management DB 42D.

Subsequently, the transmission control unit 40G is only required to read the delivery destination information, the first accommodating unit information, and the delivery destination password corresponding to the person-in-charge ID of the person-in-charge X1 selected by the selection unit 40D, from the delivery management DB 42D so as to generate delivery request information. The transmission control unit 40G is only required to transmit the generated delivery request information to the person-in-charge terminal device 14X1 of the person-in-charge X1.

Next, the management unit 40E will be described. The management unit 40E manages the delivery status information of the package 22 based on the detection result of the person-in-charge X1.

As described above, the detection result is specifically information indicating the detection result of the person-in-charge X1 who is delivering the package 22, corresponding to a time-series set of the position information of the person-in-charge X1, the person-in-charge image of the person-in-charge X1, for example.

As described above, the delivery status information is information indicating the delivery status of the package 22. Specifically, the delivery status information includes: information indicating whether the package 22 has been delivered along the delivery route illustrated in the corresponding delivery route information; information indicating the actual delivery route of the package 22, and information indicating whether the package 22 has been accommodated in the second accommodating unit 12B before the desired arrival time, information indicating whether the person-in-charge X1 is away from the box 20 by a predetermined distance or more during delivery, or information indicating whether the images of the person-in-charge at the start and end of delivery are captured images of the same person-in-charge X1.

For example, the management unit 40E registers the time-series set of the position information of the person-in-charge terminal device 14X1 of the person-in-charge X1 who is delivering the package 22, to the delivery management DB 42D, as an actual delivery route of the person-in-charge X1.

Furthermore, the management unit 40E derives whether the package 22 has been delivered along the delivery route indicated in the corresponding delivery route information, and registers the result to the delivery management DB 42D. Specifically, the management unit 40E generates delivery route information indicating a recommended delivery route for the package 22 using the delivery destination point indicated in the delivery destination information, the installation location of the first accommodating unit 12A identified by the accommodating unit ID indicated in the corresponding first accommodating unit information, a preliminarily stored route map of the public transportation F, or the like, and then registers the generated information to the delivery management DB 42D. Subsequently, the management unit 40E derives a level of matching between the delivery route indicated in the registered delivery route information and the actual delivery route of the person-in-charge X1. The management unit 40E is only required to derive the derived degree of matching as information indicating whether the package 22 has been delivered along the delivery route indicated in the corresponding delivery route information.

In addition, the management unit 40E discriminates whether the deposit time of the package 22 in the second accommodating unit 12B in the delivery management DB 42D is earlier than the desired arrival time of the corresponding delivery destination information. By this discrimination process, the management unit 40E registers, to the delivery management DB 42D, information indicating whether the package 22 has been accommodated in the second accommodating unit 12B before the desired arrival time of the requester Y.

In addition, the management unit 40E registers, to the delivery management DB 42D, information indicating whether the person-in-charge X1 is away from the box 20 by a predetermined distance or more during delivery. For example, the management unit 40E reads the position information of the person-in-charge X1 acquired from the person-in-charge terminal device 14X1 by the acquisition unit 40A and the position information of the box 20 acquired from the box 20 by the acquisition unit 40A. The management unit 40E then compares the position information of the person-in-charge X1 and the position information of the box 20 at a same acquisition timing (time), and discriminates whether these pieces of position information are away from each other by a predetermined distance or more. Subsequently, the management unit 40E registers this discrimination result to the delivery management DB 42D as information indicating whether the person-in-charge X1 is away from the box 20 by a predetermined distance or more during delivery.

In a case where the management unit 40E has discriminate that the person-in-charge X1 is away from the box 20 by a predetermined distance or more during delivery, the transmission control unit 40G may transmit error information indicating that the box 20 is in an error state to the box 20. It is only necessary on the box 20 side to output a sound indicating an error from the speaker 20F when error information is received. By this processing, it is possible to provide information to issue an alert to the person-in-charge X1 in a case where the person-in-charge X1 moves away from the box 20 during delivery, or the like.

In addition, the box 20 and the person-in-charge terminal device 14X1 may be connected by handshaking using BlueTooth (registered trademark) or the like, and a sound indicating an error may be output from the speaker 20F of the box 20 when the box 20 and the terminal device 14 are away from each other by a predetermined distance or more.

Furthermore, using a known image processing method, the management unit 40E verifies whether the delivery person image of the person-in-charge X1 at the start of delivery and the delivery person image of the person-in-charge X1 at the end of delivery are images indicating the same person-in-charge X1. Consequently, the management unit 40E is only required to register the verification result to the delivery management DB 42D as information indicating whether the person-in-charge images at the start of delivery and the end of delivery are captured images indicating the same person-in-charge X1.

In this manner, the management unit 40E derives the delivery status information of the package 22 based on the detection result of the person-in-charge X1, and updates the delivery status information of the delivery management DB 42D. The management unit 40E manages the delivery status information by using the derivation and the update.

The management unit 40E may further issue a receiving password and register the password to the delivery management DB 42D. For example, when the box 20 is accommodated in the second accommodating unit 12B by the person-in-charge X1, the management unit 40E issues a receiving password for the recipient Z. For example, by discriminating whether the second accommodating unit information is registered to the delivery management DB 42D, the management unit 40E preferably discriminates whether the box 20 is accommodated in the second accommodating unit 12B. The receiving password issued by the management unit 40E is transmitted by the transmission control unit 40G to the recipient terminal device 14Z of the recipient Z.

Next, the evaluation unit 40F will be described. The evaluation unit 40F evaluates the person-in-charge X1 based on the delivery status information. For example, the evaluation unit 40F executes an evaluation process on the person-in-charge X1 when the box 20 is accommodated in the second accommodating unit 12B by the person-in-charge X1. For example, by discriminating whether the second accommodating unit information is registered to the delivery management DB 42D, the evaluation unit 40F preferably discriminates that the box 20 is accommodated in the second accommodating unit 12B.

The evaluation unit 40F evaluates the person-in-charge X1 identified by the person-in-charge ID corresponding to the delivery status information, based on the delivery status information corresponding to the second accommodating unit information.

For example, the evaluation unit 40F derives the confidence score such that the higher confidence score will be derived in cases where: the more the package 22 is delivered along the delivery route indicated in the delivery route information; the earlier the package 22 is stored in the second accommodating unit 12B before the desired arrival time; or the less the person-in-charge X1 is away from the box 20 by a predetermined distance or more.

Furthermore, for example, the evaluation unit 40F derives a confidence score in 10 stages “0” to “1”. For example, the evaluation unit 40F sets the standard confidence score to “0.5”. The confidence score is represented by a vector norm of various factors such as the number of times of deliveries, the frequency of deliveries, the quality of deliveries, and the evaluation of deliveries. For example, the evaluation unit 40F raises the confidence score as the number of deliveries increases. Moreover, when the package 22 has arrived to be accommodated in the second accommodating unit 12B by the desired arrival time, the evaluation unit 40F determines that the delivery quality is high and raises the confidence score. In addition, the evaluation unit 40F raises the confidence score in cases where: the more regularly the delivery is performed; and the more recently the delivery has been performed. Moreover, when the evaluation unit 40F acquires information indicating a high evaluation from the requester Y, the evaluation unit 40F adds a point to raise the confidence score. In contrast, the more the delivery deviates from the delivery route, the evaluation unit 40F lowers the confidence score. In addition, the more delayed the package 22 arrives to be accommodated in the second accommodating unit 12B from the desired arrival time, the evaluation unit 40F lowers the confidence score. In addition, the evaluation unit 40F subtracts the confidence score when the information indicating the low evaluation of the requester Y is acquired.

The update unit 40J updates at least one of the usage information, confidence score, points, or delivery history, regarding the delivery person DB 42A (refer to FIG. 6).

For example, the update unit 40J updates the confidence score indicating the reliability of the person-in-charge X1 based on the evaluation result of the evaluation unit of the evaluation unit 40F. Specifically, the update unit 40J updates the confidence score by registering the confidence score derived by the evaluation unit 40F to the delivery person DB 42A in association with the corresponding delivery person ID.

In addition, the update unit 40J registers the usage information regarding the use of public transportation F acquired from the external device 16 and the delivery person terminal device 14X by the acquisition unit 40A to the delivery person DB 42A in association with the delivery person ID of the corresponding delivery person X.

For example, the sensor 11A of the gate 11 reads the usage information of the user U from an electronic device such as a terminal device 14 or an electronic medium carried by the user U passing through the gate 11. The electronic device is, for example, a terminal device such as an IC card or a mobile terminal in which an application that provides the usage information is installed.

The sensor 11A judges whether the user U identified by the personal information included in the usage information read from the electronic device, the amount of money indicated by the remaining amount information, or the like, satisfy predetermined entry permission conditions. In a case where the sensor 11A has judged that the entry permission conditions are satisfied, the sensor 11A registers the identification information of the gate 11 and the passing time of the gate 11 as usage history information and usage route information, thereby updating the usage history information stored in the electronic device. Subsequently, the sensor 11A is only required to transmit the usage information including the updated usage history information and usage route information to the external device 16.

The update unit 40J of the information processing apparatus 10 acquires usage information from the external device 16 via the acquisition unit 40A every time the usage information is updated by the external device 16. The update unit 40J is only required to register the acquired usage information to the delivery person DB 42A in association with the delivery person ID of the corresponding delivery person X.

In addition, the update unit 40J updates the delivery history of the delivery person DB 42A. For example, the update unit 40J searches the delivery management DB 42D for a person-in-charge ID having the same ID as the delivery person ID in the delivery person DB 42A. The update unit 40J is to derive the delivery history by using the delivery status information corresponding to the person-in-charge ID in the delivery management DB 42D and register the delivery history to the delivery person DB 42A.

By registering the delivery history to the delivery person DB 42A, the history of the package X will be registered to the delivery person DB 42A even when the delivery person X identified by the delivery person ID has delivered the different packages 22 in the usable area P a plurality of times without going out of the gate 11 of the usable area P. Due to this system, the delivery person X can use the delivery history to charge the requester Y or the like for the proper fee paid when using the public transportation F.

In addition, the update unit 40J updates the points in the delivery person DB 42A. For example, the update unit 40J updates the points by adding the number of points according to the confidence score each time the confidence score is newly updated. The update unit 40J may update the points such that the longer the delivery experience or the longer the delivery distance, the larger number of points will be added, based on the corresponding delivery history.

In addition, the update unit 40J may add a larger number of points as the delivery fee is higher. In addition, the update unit 40J may add a larger number of points when the package 22 is delivered along the delivery route indicated in the corresponding delivery route information, and may decrease points when the package is delivered out of the delivery route. The update unit 40J may decrease the number of points when the package 22 is delivered later than the desired arrival time. In addition, the update unit 40J may add points such that the earlier the completion of delivery of the package 22 with respect to the desired arrival time, the more the number of points will be added. Furthermore, the update unit 40J may decrease the number of points in a case where the person-in-charge X1 has been away from the box 20 by a predetermined distance or more during delivery.

Next, the first open and close control unit 40H will be described.

The first open and close control unit 40H transmits a third switching instruction and a first switching instruction to the first accommodating unit 12A.

The first switching instruction is a switching instruction for switching the door 25 of the first accommodating unit 12A, which is installed on the delivery source side of the package 22 and accommodates the package 22, from the locked state to the unlocked state. Specifically, the first switching instruction is a switching instruction for switching the door 25, which can be opened and closed toward the inside of the usable area P, from the locked state to the unlocked state in the first accommodating unit 12A. That is, the first switching instruction is a switching instruction for switching the inner door 26 of the first accommodating unit 12A from the locked state to the unlocked state.

The third switching instruction is a switching instruction for switching the door 25 that can be opened and closed toward the outside of the usable area P from the locked state to the unlocked state. That is, the third switching instruction is a switching instruction for switching the outer door 24 from the locked state to the unlocked state in the first accommodating unit 12A.

Having received the requester input information of the requester Y requesting the delivery of the package 22, the first open and close control unit 40H transmits a third switching instruction to switch the inner door 26 in the first accommodating unit 12A from the locked state to the unlocked state, to the first accommodating unit 12A.

The requester input information is information input to the information processing system 1 when the requester Y requests the delivery of the package 22. The requester input information includes at least the requester ID of the requester Y. The requester input information may be information including the requester ID and the delivery destination information.

In the present embodiment, an exemplary case where the requester input information includes the requester ID, password, and delivery destination information of the requester Y will be described.

For example, the requester Y inputs the requester input information by operating the requester terminal device 14Y. In this case, the requester terminal device 14Y transmits the requester input information to the information processing apparatus 10 via the network N. Alternatively, the requester Y may input the requester input information by operating the UI unit 32 of the first accommodating unit 12A. In this case, the first accommodating unit 12A transmits the requester input information that has received the input, to the information processing apparatus 10 via the network N.

The first open and close control unit 40H receives the requester input information from the person-in-charge terminal device 14X1 or the first accommodating unit 12A via the acquisition unit 40A. When the requester ID and password included in the requester input information are registered in the requester DB 42B, the first open and close control unit 40H is only required to transmit the third switching instruction to the first accommodating unit 12A.

The first open and close control unit 40H acquires the current position information of the requester terminal device 14Y, which is the transmission source of the requester input information, from the requester terminal device 14Y, and then specifies the accommodating unit ID of the accommodating unit 12 installed at a position closest to the requester terminal device 14Y, by using the accommodating unit DB 42C. The first open and close control unit 40H determines the specified accommodating unit ID, as accommodating unit ID of the first accommodating unit 12A. The first open and close control unit 40H is to transmit a third switching instruction to the first accommodating unit 12A identified by the accommodating unit ID.

This process brings the outer door 24 of the first accommodating unit 12A to an unlocked state. The requester Y accommodates the package 22 from the outside of the usable area P into the first accommodating unit 12A through the unlocked outer door 24 of the first accommodating unit 12A. As described above, the package 22 is accommodated in the box 20 and delivered in the present embodiment. Therefore, in the present embodiment, the requester Y disposes the package 22 in the box 20 of the first accommodating unit 12A, closes the lid 20A of the box 20, and then closes the outer door 24. By this operation, the requester Y accommodates the package 22 for which delivery is requested, in the box 20 of the first accommodating unit 12A.

Next, transmission of the first switching instruction will be described. Having received the delivery person input information of the person-in-charge X1, the first open and close control unit 40H transmits the first switching instruction for switching the door 25 of the first accommodating unit 12A installed on the delivery source side of the package 22 and accommodating the package 22 from the locked state to the unlocked state, to the first accommodating unit 12A.

The delivery person input information is information to be input to the information processing system 1 when the person-in-charge X1 starts delivery of the package 22.

The delivery person input information includes personal information of the person-in-charge X1. Specifically, the delivery person input information includes at least the delivery person ID (person-in-charge ID) of the person-in-charge X1. In the present embodiment, the delivery input information includes the person-in-charge ID of the person-in-charge X1 included in the delivery person information (refer to FIG. 6), the password included in the delivery person information, and the delivery password issued by the selection unit 40D.

For example, on the person-in-charge terminal device 14X1, the person-in-charge X1 inputs the delivery password included in the delivery request information of the person-in-charge determination notification received from the information processing apparatus 10, and the delivery person ID and password used at the time of delivery person information registration to the information processing system 1 by the person-in-charge X1, as delivery person input information.

Specifically, the person-in-charge X1 inputs the delivery person input information by operating the person-in-charge terminal device 14X1. In this case, the person-in-charge terminal device 14X1 transmits the delivery person input information to the information processing apparatus 10 via the network N. Alternatively, the person-in-charge X1 may input the delivery person input information by operating the UI unit 32 of the first accommodating unit 12A. In this case, the first accommodating unit 12A transmits the delivery person input information that has received the input, to the information processing apparatus 10 via the network N. The delivery person input information may be in the form of a code such as a barcode or a QR code (registered trademark).

The first open and close control unit 40H receives the delivery person input information from the person-in-charge terminal device 14X1 or the first accommodating unit 12A via the acquisition unit 40A. The first open and close control unit 40H discriminates whether the person-in-charge ID and the delivery password included in the delivery person input information has been registered in the delivery management DB 42D in association with the package ID of the package 22 requested to be delivered by the person-in-charge X1. In a case where there is registration as above, the first open and close control unit 40H judges that the person-in-charge X1 being the transmission source of the delivery person input information is the proper person-in-charge X1 selected by the selection unit 40D as the person-in-charge of delivery of the package 22.

Having judged that the person is the proper person-in-charge X1, the first open and close control unit 40H transmits the first switching instruction to the first accommodating unit 12A.

Specifically, having received the delivery person input information, the first open and close control unit 40H transmits the first switching instruction for switching the door 25 (inner door 26) that can be opened and closed toward the inside of the usable area P in the first accommodating unit 12A from the locked state to the unlocked state, to the first accommodating unit 12A.

Specifically, the first open and close control unit 40H specifies the accommodating unit ID and the room ID included in the first accommodating unit information corresponding to the person-in-charge ID and the delivery password included in the received delivery person input information in the delivery management DB 42D. Subsequently, the first open and close control unit 40H transmits the first switching instruction to switch the inner door 26 of the room R of the specified room ID from the locked state to the unlocked state, to the first accommodating unit 12A identified by the specified accommodating unit ID.

Accordingly, the inner door 26 of the room R of the first accommodating unit 12A that has received the first switching instruction will be switched from the locked state to the unlocked state. The person-in-charge X1 who has entered the usable area P through the gate 11 will be able to receive the box 20 accommodated in the room R of the first accommodating unit 12A from the inside of the usable area P.

Next, the second open and close control unit 40I will be described.

The second open and close control unit 40I transmits a second switching instruction and a fourth switching instruction to the second accommodating unit 12B.

The second switching instruction is a switching instruction for switching the door 25 of the second accommodating unit 12B from the locked state to the unlocked state. Specifically, the second switching instruction is a switching instruction for switching the door, which can be opened and closed toward the outside of the usable area P, from the locked state to the unlocked state in the second accommodating unit 12B. That is, the second switching instruction is a switching instruction for switching the outer door 24 of the second accommodating unit 12B from the locked state to the unlocked state.

The fourth switching instruction is a switching instruction for switching the door 25, which can be opened and closed toward the inside of the usable area P, from the locked state to the unlocked state in the second accommodating unit 12B. That is, the fourth switching instruction is a switching instruction for switching the inner door 26 from the locked state to the unlocked state in the second accommodating unit 12B.

Having received the delivery person input information, the second open and close control unit 40I transmits a fourth switching instruction to switch the inner door 26 in the second accommodating unit 12B from the locked state to the unlocked state, to the second accommodating unit 12B.

For example, the person-in-charge X1 uses the public transportation F in the usable area P to deliver the box 20 containing the package 22 to the second accommodating unit 12B installed at the delivery destination point of the package 22. Specifically, by boarding a train or the like which is the public transportation F while holding the box 20, the person-in-charge X1 delivers the box 20 to the second accommodating unit 12B installed at the delivery destination point.

Having arrived at the second accommodating unit 12B, the person-in-charge X1 inputs the delivery person input information by operating the person-in-charge terminal device 14X1. In this case, the person-in-charge terminal device 14X1 transmits the delivery person input information to the information processing apparatus 10 via the network N. Alternatively, the person-in-charge X1 may input the delivery person input information by operating the UI unit 32 of the second accommodating unit 12B. In this case, the second accommodating unit 12B transmits the delivery person input information that has received the input, to the information processing apparatus 10 via the network N.

The second open and close control unit 40I receives the requester input information from the person-in-charge terminal device 14X1 or the second accommodating unit 12B via the acquisition unit 40A. When the requester ID and the delivery password included in the requester input information are registered in the delivery management DB 42D, the second open and close control unit 40I is only required to transmit the fourth switching instruction to the second accommodating unit 12B.

For example, the second open and close control unit 40I specifies the accommodating unit 12 installed at a position closest to the delivery destination point indicated in the delivery destination information with respect to the current position indicated in the current position information of the person-in-charge terminal device 14X1 that is the transmission source of the delivery person input information, as the second accommodating unit 12B. The second open and close control unit 40I transmits the fourth switching instruction to the second accommodating unit 12B. Alternatively, the second open and close control unit 40I may specify the second accommodating unit 12B, which is the transmission source of the delivery person input information, as the second accommodating unit 12B installed at the delivery destination of the package 22, and may transmit the fourth switching instruction to the second accommodating unit 12B.

This process brings the inner door 26 of the second accommodating unit 12B to an unlocked state. The delivery person X2 accommodates the box 20 delivered within the usable area P using the public transportation F into the second accommodating unit 12B through the unlocked inner door 26 of the second accommodating unit 12B.

Next, transmission of the second switching instruction will be described.

When the package 22 is accommodated in the second accommodating unit 12B installed on the delivery destination side and second open and close control unit 40I has received the recipient input information of the recipient Z of the package 22, the second open and close control unit 40I transmits a second switching instruction to the second accommodating unit 12B.

The recipient input information is information that the recipient Z inputs to the information processing system 1 when receiving the package 22.

The recipient input information includes at least the receiving password issued for the package 22 by the management unit 40E. The recipient input information may include a recipient ID and a password used when logging in to the information processing system 1. In this case, the storage unit 42 is only required to store the recipient ID of the recipient Z in advance in association with the password.

For example, after the box 20 is accommodated in the second accommodating unit 12B and the delivery of the package 22 to the second accommodating unit 12B is completed, the transmission control unit 40G transmits a delivery completion notification to the recipient terminal device 14Z. At this time, the transmission control unit 40G transmits to the recipient terminal device 14Z the delivery completion notification including the receiving password issued for the package 22 in the box 20. The recipient Z confirms the receiving password by confirming the delivery completion notification received by the recipient terminal device 14Z. The receiving password may be in the form of a code such as a bar code or a QR code. In this case, the recipient Z is to input the recipient input information by holding the code displayed on the recipient terminal device 14Z over the UI unit 32 of the second accommodating unit 12B, or the like.

The recipient Z inputs the recipient input information by operating the recipient terminal device 14Z. In this case, the recipient terminal device 14Z transmits the recipient information that has received the input, to the information processing apparatus 10 via the network N. Alternatively, the recipient Z may input the recipient input information by operating the UI unit 32 of the second accommodating unit 12B. In this case, the second accommodating unit 12B transmits the recipient input information that has received the input, to the information processing apparatus 10 via the network N.

The second open and close control unit 40I receives the recipient input information from the recipient terminal device 14Z or the second accommodating unit 12B via the acquisition unit 40A. When the receiving password included in the recipient input information is registered in the delivery management DB 42D, the second open and close control unit 40I transmits the second switching instruction to the second accommodating unit 12B.

Specifically, having received the recipient input information, the second open and close control unit 40I transmits the second switching instruction for switching the door 25 (outer door 24) that can be opened and closed toward the outside of the usable area P in the second accommodating unit 12B, from the locked state to the unlocked state, to the second accommodating unit 12B.

Specifically, the second open and close control unit 40I specifies the accommodating unit ID and the room ID included in the second accommodating unit information corresponding to the receiving password that has been received, in the delivery management DB 42D. Subsequently, the second open and close control unit 40I transmits the second switching instruction to switch the outer door 24 of the room R of the specified room ID from the locked state to the unlocked state, to the second accommodating unit 12B identified by the specified accommodating unit ID.

Accordingly, the outer door 24 of the room R of the second accommodating unit 12B that has received the second switching instruction will be switched from the locked state to the unlocked state. The recipient Z who has received the delivery completion notification on the recipient terminal device 14Z can receive, from the box 20 accommodated in the room R of the second accommodating unit 12B, the package 22 in the box 20, from the outside of the usable area P.

[Configuration of Accommodating Unit According to Present Embodiment]

Next, the configuration of the accommodating units 12 (first accommodating unit 12A and second accommodating unit 12B) will be described. As described above, the accommodating unit 12 functions as the first accommodating unit 12A or the second accommodating unit 12B for each of the packages 22 to be delivered, depending on whether the accommodating unit 12 is located on the delivery source side or the delivery destination side of the package 22. Therefore, the first accommodating unit 12A and the second accommodating unit 12B have similar configurations except that they are installed at different positions.

As described above, the accommodating unit 12 includes: the UI unit 32, the sensor 33, the communication unit 34, the transport drive unit 35, the communication unit 36, the lock and unlock unit 37A, the lock and unlock unit 37B, the control unit 30 and a storage unit 39. Since the functions of the UI unit 32, the sensor 33, the communication unit 34, the transport drive unit 35, the communication unit 36, the lock and unlock unit 37A, and the lock and unlock unit 37B have been described above, the description thereof will be omitted here. The storage unit 39 stores various types of information. In the present embodiment, the storage unit 39 stores the accommodating unit ID of the accommodating units 12 including the storage unit 39, and the room ID of each of the rooms R provided in the accommodating units 12.

The control unit 30 includes an acquisition unit 46A, a communication control unit 46B, an open and close control unit 46C, and a transport control unit 46D. The entire or part of the acquisition unit 46A, the communication control unit 46B, the open and close control unit 46C, and the transport control unit 46D may be actualized by execution of a program by a processing device such as a CPU, that is, by software, or by hardware such as IC, or even by a combination of software and hardware.

The acquisition unit 46A acquires various types of information from the information processing apparatus 10 or the box 20. When the package 22 is newly accommodated in the present embodiment, the acquisition unit 46A notifies the communication control unit 46B of the accommodating unit information. The communication control unit 46B transmits the accommodating unit information to the information processing apparatus 10 via the communication unit 34 and the network N.

The accommodating unit information is classified into first accommodating unit information and second accommodating unit information. The first accommodating unit information is accommodating unit information transmitted by the first accommodating unit 12A to the information processing apparatus 10. The second accommodating unit information is accommodating unit information transmitted by the second accommodating unit 12B to the information processing apparatus 10.

For example, when the package 22 is newly accommodated, the acquisition unit 46A of the first accommodating unit 12A generates first accommodating unit information including the room ID of the room R in which the box 20 containing the package 22 is accommodated, the deposit time at which the package 22 is accommodated, the accommodating unit ID of the accommodating unit 12, and the box ID of the box 20. Subsequently, the communication control unit 46B of the first accommodating unit 12A transmits the first accommodating unit information to the information processing apparatus 10 via the communication unit 34 and the network N.

Moreover, when the package 22 is newly accommodated, the acquisition unit 46A of the second accommodating unit 12B generates second accommodating unit information including the room ID of the room R in which the box 20 containing the package 22 is accommodated, the deposit time at which the package 22 is accommodated, the accommodating unit ID of the accommodating unit 12, and the box ID of the box 20. Subsequently, the communication control unit 46B of the second accommodating unit 12B transmits the second accommodating unit information to the information processing apparatus 10 via the communication unit 34 and the network N.

The acquisition unit 46A is only required to acquire the room ID of the room R in which the sensor 33 is installed and the box ID of the box 20, from the sensor 33 installed in each of the rooms R. The sensor 33 is only required to acquire the box ID by receiving the box ID of the box 20, from the box 20 in the room R in which the sensor 33 is installed.

Furthermore, the acquisition unit 46A acquires various types of information such as the first switching instruction, the second switching instruction, the third switching instruction, and the fourth switching instruction from the information processing apparatus 10 via the communication unit 34 and the network N.

The open and close control unit 46C switches the door 25 from the locked state to the unlocked state in response to the switching instruction.

For example, having received the first switching instruction from the information processing apparatus 10, the open and close control unit 46C of the first accommodating unit 12A switches the inner door 26 of the first accommodating unit 12A from the locked state to the unlocked state. The first switching instruction includes the room ID in some cases. In this case, the open and close control unit 46C of the first accommodating unit 12A is only required to switch the inner door 26 of the room R identified by the room ID in the first accommodating unit 12A, from the locked state to the unlocked state.

Moreover, having received the third switching instruction from the information processing apparatus 10, the open and close control unit 46C of the first accommodating unit 12A switches the outer door 24 of the first accommodating unit 12A from the locked state to the unlocked state. The third switching instruction includes the room ID in some cases. In this case, the open and close control unit 46C of the first accommodating unit 12A is only required to switch the outer door 24 of the room R identified by the room ID in the first accommodating unit 12A, from the locked state to the unlocked state.

Furthermore, as described with reference to FIGS. 4A to 4F, at this time, the transport control unit 46D of the first accommodating unit 12A controls the transport drive unit 35 to control the drive of the partition member 27.

Similarly, having received the fourth switching instruction from the information processing apparatus 10, the open and close control unit 46C of the second accommodating unit 12B switches the inner door 26 of the second accommodating unit 12B from the locked state to the unlocked state. The fourth switching instruction includes the room ID in some cases. In this case, the open and close control unit 46C of the second accommodating unit 12B is only required to switch the inner door 26 of the room R identified by the room ID in the second accommodating unit 12B from the locked state to the unlocked state.

Moreover, having received the second switching instruction from the information processing apparatus 10, the open and close control unit 46C of the second accommodating unit 12B switches the outer door 24 of the second accommodating unit 12B from the locked state to the unlocked state. The second switching instruction includes the room ID in some cases. In this case, the open and close control unit 46C of the second accommodating unit 12B is only required to switch the outer door 24 of the room R identified by the room ID in the second accommodating unit 12B from the locked state to the unlocked state.

Furthermore, as described with reference to FIGS. 4A to 4F, at this time, the transport control unit 46D of the second accommodating unit 12B controls the transport drive unit 35 to control the drive of the partition member 27.

[Configuration of Box According to Present Embodiment]

Next, a configuration of the box 20 will be described. As described above, the box 20 includes the lid 20A, the imaging unit 20B, the display unit 20C, the GPS 20D, the scanner unit 20E, the speaker 20F, the communication unit 20G, the control unit 20H, the lock and unlock unit 20J, and a storage unit 20K. Since the functions of the lid 20A, the imaging unit 20B, the display unit 20C, the GPS 20D, the scanner unit 20E, the speaker 20F, the communication unit 20G, and the lock and unlock unit 20J have been described above, description thereof will be omitted here.

The storage unit 20K stores various types of information. In the present embodiment, the storage unit 20K stores the box ID of the box 20 and display information received from the information processing apparatus 10 or the first accommodating unit 12A. The display information is information for displaying on the display unit 20C that functions as an electronic label. For example, the display information includes a delivery destination point and a desired arrival time included in the delivery destination information of the package 22.

The control unit 20H individually controls the display unit 20C, the imaging unit 20B, the GPS 20D, the scanner unit 20E, the speaker 20F, and the lock and unlock unit 20J in accordance with various types of information acquired from the first accommodating unit 12A.

For example, the control unit 20H controls the lock and unlock unit 20J so as to switch the lid 20A of the box 20 from the locked state to the unlocked state when the first accommodating unit 12A accommodating the box 20 receives the first switching instruction from the information processing apparatus 10. That is, the box 20 accommodated in the first accommodating unit 12A is switched from the locked state to the unlocked state when the first accommodating unit 12A receives the first switching instruction.

Furthermore, the control unit 20H controls the lock and unlock unit 20J so as to switch the imaging unit 20B of the box 20 from the locked state to the unlocked state when the second accommodating unit 12B accommodating the box 20 receives the second switching instruction from the information processing apparatus 10. That is, the box 20 accommodated in the second accommodating unit 12B is switched from the locked state to the unlocked state when the second accommodating unit 12B receives the second switching instruction.

[Information Processing Procedure According to Present Embodiment]

Next, an example of the information processing procedure executed by the information processing system 1 of the present embodiment will be described.

[Delivery Person Registration Procedure According to Present Embodiment]

[Delivery Person Registration Process]

First, an example of the procedure of a registration process of the delivery person X executed by the information processing system 1 will be described.

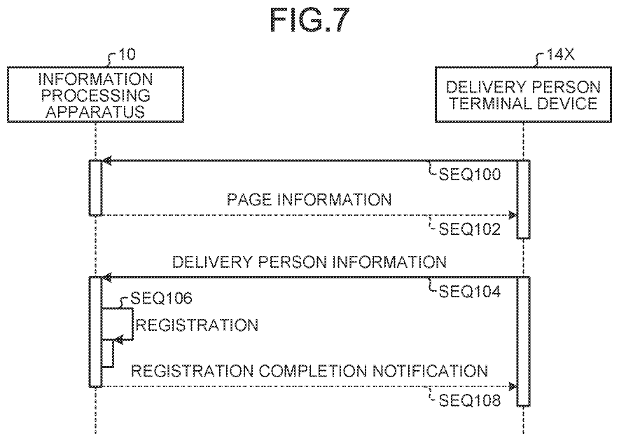

FIG. 7 is a sequence diagram illustrating an example of the procedure of the registration process of the delivery person X. The delivery person terminal device 14X of the delivery person X transmits a request for an input screen for registering the delivery person information, to the information processing apparatus 10 (SEQ 100). Having received the request from the delivery person terminal device 14X, the acquisition unit 40A of the information processing apparatus 10 transmits page information of the input screen to the recipient terminal device 14Z (SEQ 102).

By operating the delivery person terminal device 14X, the delivery person X inputs the delivery person information of the delivery person X via the input screen displayed on the delivery person terminal device 14X. Subsequently, the delivery person terminal device 14X transmits the input delivery person information to the information processing apparatus 10 (SEQ 104).

Having received the delivery person information acquired from the delivery person terminal device 14X by the acquisition unit 40A, the registration unit 40B of the information processing apparatus 10 registers the delivery person information to the delivery person DB 42A (refer to FIG. 6) (SEQ 106). Subsequently, the transmission control unit 40G of the information processing apparatus 10 transmits a registration completion notification indicating the completion of registration of the delivery person information to the delivery person terminal device 14X (SEQ 108).

With execution of the registration process illustrated in FIG. 7, the delivery person information of one or more delivery persons X is individually registered to the delivery person DB 42A of the information processing apparatus 10.

[Package Deposit Process]

Next, an example of a procedure of a deposit process for the package 22 will be described.

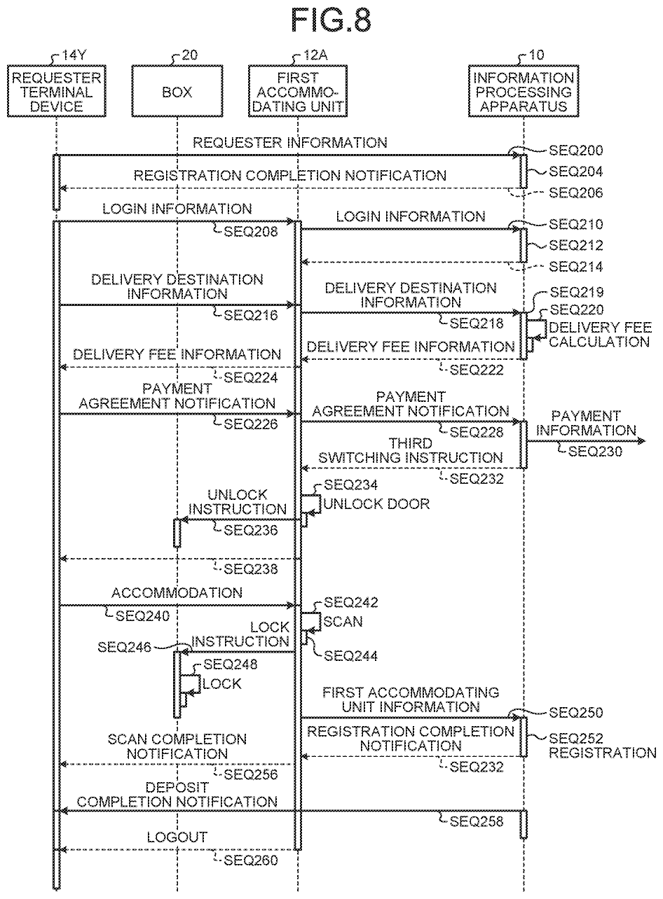

FIG. 8 is a sequence diagram illustrating an example of a procedure of a deposit process for the package 22. FIG. 8 illustrates an exemplary case where the requester terminal device 14Y and the information processing apparatus 10 communicate with each other via the first accommodating unit 12A except for a part of information. Note that the requester terminal device 14Y and the information processing apparatus 10 may directly transfer all the information in mutual communication.

First, the requester Y operates the requester terminal device 14Y to input the requester information of the requester Y. Subsequently, the requester terminal device 14Y transmits the input requester information to the information processing apparatus 10 (SEQ 200). The registration unit 40B of the information processing apparatus 10 registers the requester information acquired from the requester terminal device 14Y by the acquisition unit 40A, to the requester DB 42B (refer to FIG. 6) (SEQ 204). Accordingly, the requester information of the requester Y who requests the delivery of the package 22 is sequentially registered to the requester DB 42B. Subsequently, the transmission control unit 40G of the information processing apparatus 10 transmits a registration completion notification indicating the completion of registration of the requester information to the requester terminal device 14Y (SEQ 206).

Next, the requester Y operates the requester terminal device 14Y to input the requester input information. As described above, the requester input information may be information including the requester ID and the delivery destination information. Here, an exemplary case where the requester input information includes the requester ID and the delivery destination information will be described.

For example, the requester Y operates the requester terminal device 14Y to input login information including the requester ID and password of the requester Y. Having received the input, the requester terminal device 14Y transmits the login information to the first accommodating unit 12A (SEQ 208). The acquisition unit 46A of the first accommodating unit 12A acquires the login information from the requester terminal device 14Y via the communication unit 34. The communication control unit 46B of the first accommodating unit 12A transmits the login information received from the requester terminal device 14Y to the information processing apparatus 10 (SEQ 210).

The registration unit 40B of the information processing apparatus 10 judges whether the requester ID and password included in the login information received from the first accommodating unit 12A via the acquisition unit 40A are registered in the requester DB 42B in association with each other (SEQ 212). Here, the description will continue on the assumption that the registration has been performed. The transmission control unit 40G of the information processing apparatus 10 transmits information indicating a permission to log in to the information processing system 1 to the first accommodating unit 12A (SEQ 214).

Next, the requester Y inputs the delivery destination information by operating the requester terminal device 14Y. Having received the input of delivery destination information, the requester terminal device 14Y transmits the delivery destination information to the first accommodating unit 12A (SEQ 216). The communication control unit 46B of the first accommodating unit 12A transmits the delivery destination information acquired from the requester terminal device 14Y by the acquisition unit 46A, to the information processing apparatus 10 (SEQ 218).

The acquisition unit 40A of the information processing apparatus 10 acquires delivery destination information from the requester terminal device 14Y via the first accommodating unit 12A. The registration unit 40B of the information processing apparatus 10 assigns a new package ID, and registers the package ID, the requester ID included in the login information received in SEQ 210, and the delivery destination information acquired in SEQ 218 to the delivery management DB 42D in association with each other (SEQ 219). The calculation unit 40C of the information processing apparatus 10 then calculates the delivery fee of the package 22 based on the acquired delivery destination information (SEQ 220). Subsequently, the registration unit 40B of the information processing apparatus 10 registers the delivery fee calculated by the calculation unit 40C to the delivery management DB 42D in association with the delivery destination information received in SEQ 218.

The transmission control unit 40G transmits the delivery fee information indicating the delivery fee calculated in SEQ 220, to the first accommodating unit 12A (SEQ 222). The communication control unit 46B of the first accommodating unit 12A transmits the delivery fee information received from the information processing apparatus 10 to the requester terminal device 14Y (SEQ 224).

In a case where the requester Y who operates the requester terminal device 14Y agrees to the delivery fee indicated by the delivery fee information received by the requester terminal device 14Y, the requester Y inputs an operation indicating payment agreement. In response to this operation, the requester terminal device 14Y transmits a payment agreement notification to the first accommodating unit 12A (SEQ 226). The communication control unit 46B of the first accommodating unit 12A transmits the payment agreement notification received from the requester terminal device 14Y to the information processing apparatus 10 (SEQ 228).

The transmission control unit 40G of the information processing apparatus 10 transmits payment information including the requester ID contained in the login information received in SEQ 210 and the delivery fee information calculated in SEQ 220, to the external device 16 (SEQ 230). In this case, the transmission control unit 40G is only required to transmit the payment information to the external device 16 that manages a known payment system that collects charges from the user U′s account or the like. The registration unit 40B of the information processing apparatus 10 registers the payment status “completed” to the delivery management DB 42D in association with the delivery destination information received in SEQ 218.

Next, the first open and close control unit 40H of the information processing apparatus 10 transmits a third switching instruction for switching the inner door 26 in the first accommodating unit 12A from the locked state to the unlocked state, to the first accommodating unit 12A (SEQ 232). That is, having received requester input information (login information and delivery destination information) in SEQ 210 and SEQ 218, the first open and close control unit 40H transmits the third switching instruction to the first accommodating unit 12A.

Having received the third switching instruction from the information processing apparatus 10 via the acquisition unit 46A, the open and close control unit 46C of the first accommodating unit 12A switches the outer door 24 of the first accommodating unit 12A from the locked state to the unlocked state (SEQ 234). At this time, the open and close control unit 46C of the first accommodating unit 12A switches the outer door 24 of the room R accommodating an empty box 20 not accommodating the package 22 among the plurality of rooms R of the first accommodating unit 12A, from the locked state to the unlocked state.

Furthermore, the communication control unit 46B of the first accommodating unit 12A transmits an unlock instruction regarding the lid 20A of the box 20 disposed in the room R unlocked in SEQ 234 of the first accommodating unit 12A, to the box 20 (SEQ 236). Having received the unlock instruction, the control unit 20H of the box 20 controls the lock and unlock unit 20J to unlock the lid 20A.

The requester Y accommodates the package 22 to be delivered in the unlocked box 20 disposed in the room R communicating with the outer door 24 through the outer door 24 of the unlocked first accommodating unit 12A (SEQ 238 and SEQ 240). After closing the lid 20A of the box 20, the requester Y closes the outer door 24 of the first accommodating unit 12A.

Next, the communication control unit 46B of the first accommodating unit 12A transmits a scan instruction to the box (SEQ 242). With the process of SEQ 242, the scanner unit 20E of the box 20 scans the package 22 contained in the box 20 and detects whether the package 22 has a predetermined characteristic as a dangerous item. Here, the description will continue assuming that the package 22 is not a dangerous item. In a case where the scanner unit 20E determines that the package 22 is a dangerous or hazardous item, a communication control unit 46BH of the first accommodating unit 12A preferably transmits an error message to the requester terminal device 14Y and the information processing apparatus 10 so as to terminate this sequence.

Next, the open and close control unit 46C of the first accommodating unit 12A switches the outer door 24, which has been switched to the unlocked state in SEQ 234, to the locked state (SEQ 244). In response to this, the transport control unit 46D of the first accommodating unit 12A transmits a lock instruction to the box 20 (SEQ 246). The control unit 20H of the box 20 controls the lock and unlock unit 20J to lock the lid 20A (SEQ 248).

Next, the communication control unit 46B of the first accommodating unit 12A transmits first accommodating unit information including the deposit time, the accommodating unit ID, the room ID, and the box ID to the information processing apparatus 10 (SEQ 250). For example, the communication control unit 46B uses the time when the package 22 is accommodated in the box 20 in SEQ 240, as the deposit time. Furthermore, the communication control unit 46B specifies the room ID of the room R communicating with the outer door 24 unlocked in SEQ 234 and the box ID of the box 20 accommodated in the room R. The communication control unit 46B is only required to transmit the first accommodating unit information including the deposit time, the room ID, the box ID, and the accommodating unit ID of the first accommodating unit 12A, to the information processing apparatus 10.

Having received the first accommodating unit information from the first accommodating unit 12A, the registration unit 40B of the information processing apparatus 10 registers the first accommodating unit information to the delivery management DB 42D in association with the delivery destination information received from the requester terminal device 14Y in SEQ 218 (SEQ 252).

Subsequently, the transmission control unit 40G of the information processing apparatus 10 transmits a registration completion notification indicating the completion of registration of the delivery destination information, to the first accommodating unit 12A (SEQ 254). The communication control unit 46B of the first accommodating unit 12A transmits a scan completion notification indicating the completion of scanning of the package 22 to the requester terminal device 14Y (SEQ 256).

Furthermore, the transmission control unit 40G of the information processing apparatus 10 transmits a deposit completion notification indicating the completion of deposit of the package 22, to the requester terminal device 14Y (SEQ 258). Subsequently, the first accommodating unit 12A executes a process of logout from the information processing system 1 of the requester Y (SEQ 260).

In the first accommodating unit 12A, with execution of the deposit process illustrated in FIG. 8, a package 22 is accommodated in the box 20 of the first accommodating unit 12A by the requester Y from the outside of the usable area P. Subsequently the outer door 24 and the box 20 of the first accommodating unit 12A are brought into the locked state. In addition, the delivery destination information of the package 22 is registered to the information processing apparatus 10.

[Package Delivery Process]

Next, an example of the procedure of a delivery process for the package 22 will be described.

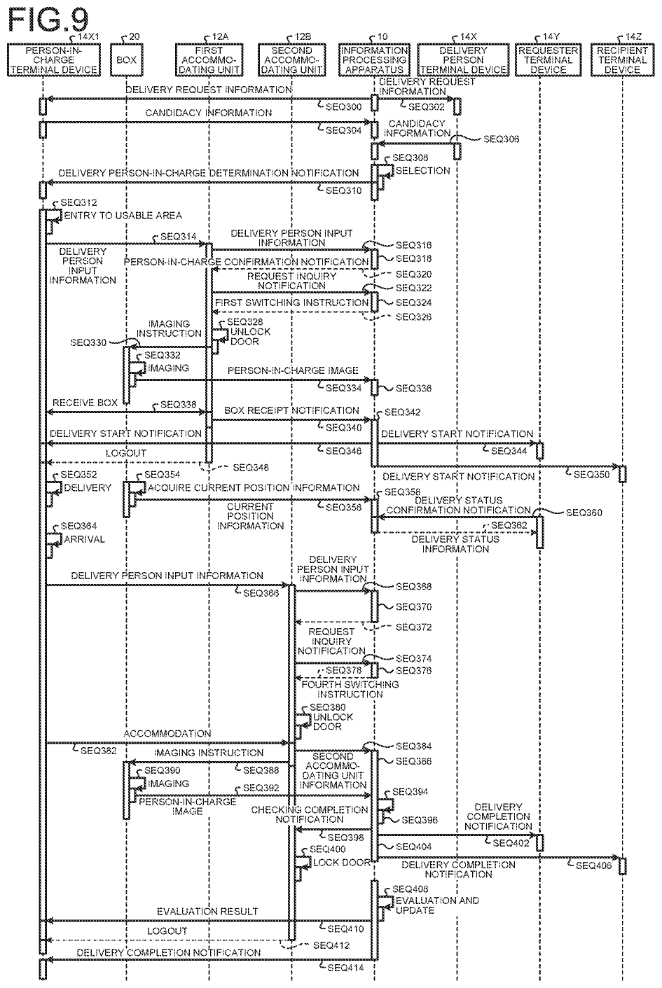

FIG. 9 is a sequence diagram illustrating an example of a procedure of a delivery process for the package 22. FIG. 9 illustrates an exemplary case where the person-in-charge terminal device 14X1 and the information processing apparatus 10 communicate with each other via the first accommodating unit 12A and the second accommodating unit 12B except for a part of information. Note that the person-in-charge terminal device 14X1 and the information processing apparatus 10 may directly transfer all the information in mutual communication.

When the new delivery destination information has been registered to the delivery management DB 42D, the control unit 40 of the information processing apparatus 10 executes the procedure of a delivery process illustrated in FIG. 9. For example, it is assumed that the information processing apparatus 10 has received new delivery destination information in the preceding SEQ 218 (refer to FIG. 8). In this case, the information processing system 1 executes the following sequence according to the delivery destination information. In the following, the delivery destination information may be referred to as delivery destination information to be processed.

For example, the transmission control unit 40G of the information processing apparatus 10 transmits delivery request information individually to one or more delivery persons X having delivery person management information registered in the delivery person DB 42A (SEQ 300 and SEQ 302).

The delivery request information includes a delivery destination point and a desired arrival time included in the delivery destination information, for example. The delivery destination information may further include the amount of payment for the delivery. In this case, the transmission control unit 40G of the information processing apparatus 10 is only required to use the delivery destination information and the calculated delivery fee to calculate the amount of payment by using a predetermined function.

In a case where the delivery person X who operates the delivery person terminal device 14X that has received a delivery request information desires to be in charge of delivery, the delivery person X operates the delivery person terminal device 14X to input information indicating a candidacy for the delivery. The delivery person terminal device 14X that has received the input of the information indicating the candidacy transmits the candidacy information to the information processing apparatus 10 (SEQ 304 and SEQ 306).

The selection unit 40D of the information processing apparatus 10 selects the person-in-charge X1 (SEQ 308). Based on the delivery destination information to be processed and the delivery person management information of the delivery person X who operates the delivery person terminal device 14X being the transmission source of the candidacy information received in SEQ 304 to SEQ 306, the selection unit 40D selects at least one of the plurality of candidates for the delivery persons X in charge of the package, as the person-in-charge X1 of the package 22 (SEQ 308). Subsequently, the selection unit 40D registers the delivery person ID of the selected person-in-charge X1 as the person-in-charge ID to the delivery management DB 42D in association with the delivery destination information to be processed. In addition, the selection unit 40D issues a delivery password for the selected person-in-charge X1 and registers the password to the delivery management DB 42D in association with the delivery destination information of a delivery target.

Then, the transmission control unit 40G of the information processing apparatus 10 transmits a person-in-charge determination notification including the delivery request information to the person-in-charge terminal device 14X1 of the person-in-charge X1 selected in SEQ 308 (SEQ 310). As described above, the delivery request information includes the delivery destination point, the desired arrival time, the installation location information of the first accommodating unit 12A in which the package 22 is stored, and the delivery password.

The person-in-charge X1 carrying the person-in-charge terminal device 14X1 enters the usable area P through the gate (SEQ 312). Subsequently, the person-in-charge X1 moves to the installation location indicated by the installation location information of the first accommodating unit 12A included in the person-in-charge determination notification received in SEQ 310. That is, the person-in-charge X1 is located inside the usable area P in the first accommodating unit 12A.

Next, the person-in-charge X1 inputs the delivery person input information by operating the person-in-charge terminal device 14X1. The person-in-charge terminal device 14X1 transmits the delivery person input information that has received the input to the first accommodating unit 12A (SEQ 314). The person-in-charge X1 may input the delivery person input information into the first accommodating unit 12A by operating the UI unit 32 of the first accommodating unit 12A.

The communication unit 34 of the first accommodating unit 12A transmits the delivery person input information received in SEQ 314 to the information processing apparatus 10 (SEQ 316). The first open and close control unit 40H of the information processing apparatus 10 receives the delivery person input information via the acquisition unit 40A. The first open and close control unit 40H of the information processing apparatus 10 discriminates whether the person-in-charge ID and the delivery password included in the delivery person input information are registered in the delivery management DB 42D in association with the delivery destination information to be processed. In a case where there is registration as above, the first open and close control unit 40H judges that the person-in-charge X1 being the transmission source of the delivery person input information is the proper person-in-charge X1 selected by the selection unit 40D (SEQ 318). Here, it is assumed that the person-in-charge X is judged to be a proper person-in-charge X1, and description will continue.

The first open and close control unit 40H of the information processing apparatus 10 transmits a person-in-charge confirmation notification indicating that the person-in-charge X1 has been confirmed to the first accommodating unit 12A (SEQ 320). The communication control unit 46B of the first accommodating unit 12A transmits a request inquiry notification indicating the request inquiry to the information processing apparatus 10 (SEQ 322).

The first open and close control unit 40H of the information processing apparatus 10 transmits the first switching instruction to the first accommodating unit 12A (SEQ 324 and SEQ 326). Specifically, having received the delivery person input information in SEQ 316, the first open and close control unit 40H transmits the first switching instruction for switching the door 25 (inner door 26) that can be opened and closed toward the inside of the usable area P in the first accommodating unit 12A, from the locked state to the unlocked state, to the first accommodating unit 12A.

At this time, the first open and close control unit 40H reads the first accommodating unit information corresponding to the delivery destination information to be processed from the delivery management DB 42D, and transmits the first switching instruction including the room ID included in the first accommodating unit information to the first accommodating unit 12A. At this time, the first open and close control unit 40H is only required to transmit the first switching instruction to the first accommodating unit 12A identified by the accommodating unit ID included in the first accommodating unit information.

Having received the first switching instruction from the information processing apparatus 10 via the acquisition unit 46A, the open and close control unit 46C of the first accommodating unit 12A switches the inner door 26 of the room R identified by the room ID included in the first switching instruction, from the locked state to the unlocked state (SEQ 328).

Therefore, the person-in-charge X1 located in front of the first accommodating unit 12A in the usable area P is enabled to open the inner door 26 and visually recognize the box 20 in the room R. When the person-in-charge X1 opens the inner door 26, the communication control unit 46B of the first accommodating unit 12A transmits an imaging instruction to the box 20 in the room R (SEQ 330).

The control unit 20H of the box 20 that receives the imaging instruction controls the imaging unit 20B to execute imaging (SEQ 332). Here, as described above, the imaging unit 20B is provided on the outer side wall of the box 20. Furthermore, the box 20 is arranged in the accommodating unit 12 so that the inner door 26 side, that is, the inside of the usable area P can be imaged in the accommodating unit 12. Therefore, the imaging unit 20B images the person-in-charge X1 who opened the inner door 26 and obtains the person-in-charge image.

The control unit 20H of the box 20 transmits the person-in-charge image captured in SEQ 332 as an image of the person-in-charge at the start of delivery, to the information processing apparatus 10 via the first accommodating unit 12A (SEQ 334). The registration unit 40B of the information processing apparatus 10 registers the person-in-charge image at the start of delivery received via the acquisition unit 40A to the delivery management DB 42D in association with the delivery destination information to be processed (SEQ 336).

The person-in-charge X1 receives the box 20 accommodated in the room R through the inner door 26 which has been switched to the unlocked state in SEQ 328 (SEQ 338).

At this time, the sensor 33 of the first accommodating unit 12A detects that the box 20 has been taken out of the room R. The communication control unit 46B of the first accommodating unit 12A transmits a box receipt notification indicating that the box 20 has been received to the information processing apparatus 10 (SEQ 340).

Having received the box receipt notification, the registration unit 40B of the information processing apparatus 10 registers the current time as the delivery start time to the delivery management DB 42D in association with the delivery destination information to be processed (SEQ 342).

Next, the transmission control unit 40G of the information processing apparatus 10 transmits a delivery start notification indicating the start of delivery to the requester terminal device 14Y of the requester Y, the person-in-charge terminal device 14X1 of the person-in-charge X1, and each of the recipient terminal devices 14Z of the recipients Z (SEQ 344, SEQ 346, and SEQ 350). Having received the delivery start notification, person-in-charge X1 of the person-in-charge terminal device 14X1 logs out from the information processing system 1 (SEQ 348).

Subsequently, the person-in-charge X1 takes out the box 20 disposed in the inner door 26 unlocked in SEQ 328 through the first accommodating unit 12A, and starts delivery of the box 20 to the delivery destination (SEQ 352). Specifically, the person-in-charge X1 holds the box 20 and gets on the public transportation F, and delivers the box 20 in the direction of the delivery destination point included in the delivery request information received in SEQ 300.

At this time, the control unit 20H of the box 20 acquires the current position information of the box 20 from the GPS 20D (SEQ 354) and transmits the information to the information processing apparatus 10 via the communication unit 20G (SEQ 356). The control unit 20H of the box 20 repeatedly transmits the current position information of the box 20 to the information processing apparatus 10 at predetermined time intervals until the box 20 is accommodated in the second accommodating unit 12B as the delivery destination.

Every time the management unit 40E of the information processing apparatus 10 acquires the current position information from the box 20, the management unit 40E updates the delivery status information corresponding to the delivery destination information to be processed, within the delivery management DB 42D (SEQ 358).

At this time, when the management unit 40E discriminates that the person-in-charge X1 is away from the box 20 by a predetermined distance or more during delivery, the transmission control unit 40G of the information processing apparatus 10 transmits error information to the box 20. Having received the error information, the box 20 outputs a sound indicating an error from the speaker 20F. By this processing, it is possible to provide information to issue an alert to the person-in-charge X1 in a case where the person-in-charge X1 moves away from the box 20 during delivery.

Next, the acquisition unit 40A of the information processing apparatus 10 receives the delivery status confirmation notification from the requester terminal device 14Y (SEQ 360). In response to this, the transmission control unit 40G of the information processing apparatus 10 reads the delivery status information corresponding to the requester ID of the requester terminal device 14Y from the delivery management DB 42D and transmits the information to the requester terminal device 14Y (SEQ 362).

Meanwhile, the person-in-charge X1 arrives in front of the second accommodating unit 12B located on the delivery destination side (SEQ 364). The person-in-charge X1 inputs the delivery person input information by operating the person-in-charge terminal device 14X1. The person-in-charge terminal device 14X1 transmits the delivery person input information that has received the input, to the second accommodating unit 12B (SEQ 366). The person-in-charge X1 may input the delivery person input information into the first accommodating unit 12A by operating the UI unit 32 of the second accommodating unit 12B.

The communication unit 34 of the second accommodating unit 12B transmits the delivery person input information received in SEQ 366 to the information processing apparatus 10 (SEQ 368). The second open and close control unit 40I of the information processing apparatus 10 receives the delivery person input information via the acquisition unit 40A. The second open and close control unit 40I of the information processing apparatus 10 discriminates whether the person-in-charge ID and the delivery password included in the delivery person input information are registered in the delivery management DB 42D in association with the delivery destination information to be processed. In a case where there is registration as above, the second open and close control unit 40I judges that the person-in-charge X1 being the transmission source of the delivery person input information is the proper person-in-charge X1 selected by the selection unit 40D (SEQ 370). Here, it is assumed that the person-in-charge X is judged to be a proper person-in-charge X1, and description will continue.

Then, the second open and close control unit 40I of the information processing apparatus 10 transmits a person-in-charge confirmation notification indicating that the person-in-charge X1 has been confirmed, to the second accommodating unit 12B (SEQ 372). The communication control unit 46B of the second accommodating unit 12B transmits a request inquiry notification indicating the request inquiry to the information processing apparatus 10 (SEQ 374).

Then, the second open and close control unit 40I of the information processing apparatus 10 transmits the fourth switching instruction to the second accommodating unit 12B (SEQ 376 and SEQ 378). That is, having received the delivery person input information, the second open and close control unit 40I transmits a fourth switching instruction to switch the inner door 26 in the second accommodating unit 12B from the locked state to the unlocked state, to the second accommodating unit 12B.

Having received the fourth switching instruction from the information processing apparatus 10 via the acquisition unit 46A, the open and close control unit 46C of the second accommodating unit 12B switches the inner door 26 of the second accommodating unit 12B from the locked state to the unlocked state (SEQ 380). At this time, the open and close control unit 46C of the second accommodating unit 12B switches the inner door 26 of an empty room R not accommodating any package 22 or the box 20 inside, among the plurality of rooms R of the second accommodating unit 12B from the locked state to the unlocked state.

Via the inner door 26 of the second accommodating unit 12B unlocked by the processing in SEQ 380, the person-in-charge X1 accommodates the delivered box 20 in the room R communicating with the inner door 26 and then closes the inner door 26 (SEQ 382).

The communication control unit 46B of the second accommodating unit 12B transmits the second accommodating unit information including the deposit time, the accommodating unit ID, the room ID, and the box ID, to the information processing apparatus 10 (SEQ 384). For example, the communication control unit 46B uses the time when the package 22 is accommodated in the box 20 in SEQ 382, as the deposit time. Furthermore, the communication control unit 46B specifies the room ID of the room R communicating with the inner door 26 unlocked in SEQ 380 and the box ID of the box 20 accommodated in the room R. The communication control unit 46B is only required to transmit the second accommodating unit information including the deposit time, the room ID, the box ID, and the accommodating unit ID of the second accommodating unit 12B, to the information processing apparatus 10.

Having received the second accommodating unit information from the second accommodating unit 12B, the registration unit 40B of the information processing apparatus 10 registers the second accommodating unit information to the delivery management DB 42D in association with the person-in-charge ID and the delivery password included in the delivery person input information received in SEQ 368 (SEQ 386).

When the person-in-charge X1 accommodates the box 20 in the room R in the above SEQ 382, the communication control unit 46B of the second accommodating unit 12B transmits an imaging instruction to the box 20 (SEQ 388).

Having received the imaging instruction, the control unit 20H of the box 20 controls the imaging unit 20B to execute imaging (SEQ 390). Here, as described above, the imaging unit 20B is provided on the outer side wall of the box 20. Furthermore, the box 20 is arranged in the accommodating unit 12 so that the inner door 26 side, that is, the inside of the usable area P can be imaged in the accommodating unit 12. Therefore, the imaging unit 20B images the person-in-charge X1 who opened the inner door 26 and obtains the person-in-charge image.

The control unit 20H of the box 20 transmits the person-in-charge image captured in SEQ 390 to the information processing apparatus 10 via the second accommodating unit 12B as a person-in-charge image at the end of delivery (SEQ 392). The registration unit 40B of the information processing apparatus 10 registers the person-in-charge image at the end of delivery received via the acquisition unit 40A to the delivery management DB 42D in association with the person-in-charge ID and the delivery password included in the delivery person input information received in SEQ 368 (SEQ 394).

The management unit 40E checks whether the person-in-charge image at the end of delivery registered in the delivery management DB 42D in SEQ 394 and the person-in-charge image at the start of delivery corresponding to the person-in-charge image in the delivery management DB 42D are the captured images indicating the same person-in-charge X1 (SEQ 396). The management unit 40E registers the checking result as information included in the delivery status information of the delivery management DB 42D, thereby updating the delivery status information.

The transmission control unit 40G of the information processing apparatus 10 transmits a checking completion notification to the second accommodating unit 12B (SEQ 398). Having received the checking completion notification, the open and close control unit 46C of the second accommodating unit 12B locks the inner door 26 of the room R that accommodated the box 20 in SEQ 382 (SEQ 400).

Next, the transmission control unit 40G of the information processing apparatus 10 transmits a delivery completion notification indicating the completion of delivery to the requester terminal device 14Y (SEQ 402). In addition, the management unit 40E of the information processing apparatus 10 issues a receiving password for the package 22 (SEQ 404). The management unit 40E of the information processing apparatus 10 registers the receiving password to the delivery management DB 42D in association with the person-in-charge ID and the delivery password included in the delivery person input information received in SEQ 368.

Furthermore, the transmission control unit 40G of the information processing apparatus 10 transmits a delivery completion notification including the receiving password issued in SEQ 404 and the installation location information of the second accommodating unit 12B, to the recipient terminal device 14Z (SEQ 406).

Next, the evaluation unit 40F and the update unit 40J of the information processing apparatus 10 evaluate the person-in-charge X1 and update the delivery person DB 42A based on the delivery status information (SEQ 408).

The transmission control unit 40G of the information processing apparatus 10 transmits an evaluation result obtained by the evaluation unit 40F to the person-in-charge terminal device 14X1 (SEQ 410). Following this, the second accommodating unit 12B executes a logout process of the person-in-charge X1 from the information processing system 1 (SEQ 412). The transmission control unit 40G of the information processing apparatus 10 transmits a delivery completion notification indicating the completion of delivery to the delivery person terminal device 14X (SEQ 414).

With execution of the delivery process illustrated in FIG. 9, the box 20 containing the package 22 and accommodated in the first accommodating unit 12A is taken out by the person-in-charge X1 from the inside of the usable area P through the inner door 26. With the use of the public transportation F by the person-in-charge X1, the box 20 is delivered in a direction of the second accommodating unit 12B installed at the delivery destination in the usable area P. After arriving at the second accommodating unit 12B installed at the delivery destination, the person-in-charge X1 holding the box 20 accommodates the box 20 in the second accommodating unit 12B via the inner door 26 that opens and closes toward the inside of the usable area P in the second accommodating unit 12B.

[Package Reception Process]

Next, an example of the procedure of a receiving process for the package 22 will be described.

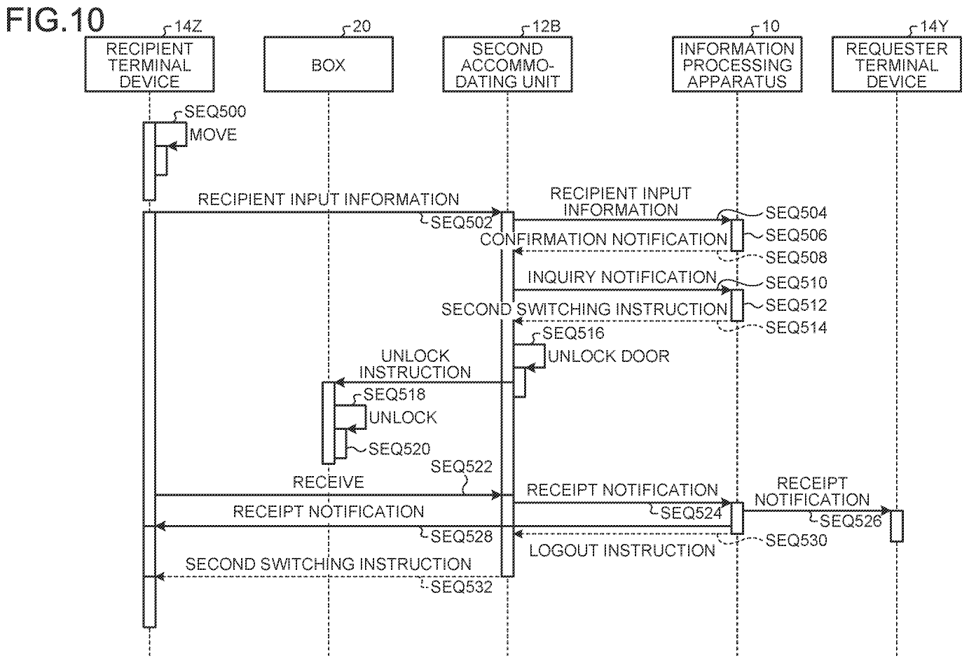

FIG. 10 is a sequence diagram illustrating an example of a procedure of a reception process for the package 22. Note that FIG. 10 illustrates an exemplary case where the recipient terminal device 14Z and the information processing apparatus 10 communicate with each other via the second accommodating unit 12B except for a part of information. The recipient terminal device 14Z and the information processing apparatus 10 may directly transfer all the information in mutual communication.

Having received the delivery completion notification including the receiving password by the process in the above SEQ 406 (refer to FIG. 9), the recipient terminal device 14Z moves to the installation location of the second accommodating unit 12B together with the movement of the recipient Z to the installation location indicated in the installation location information included in the delivery completion notification (SEQ 500).

Next, the recipient Z inputs the recipient input information by operating the recipient terminal device 14Z. By operating the recipient terminal device 14Z, the recipient Z inputs the receiving password included in the delivery completion notification received in SEQ 406 (refer to FIG. 9), thereby inputting the recipient input information. The recipient terminal device 14Z transmits the recipient input information that has received the input, to the second accommodating unit 12B (SEQ 502). Alternatively, the recipient Z may input the recipient input information into the second accommodating unit 12B by operating the UI unit 32 of the second accommodating unit 12B.

The communication unit 34 of the second accommodating unit 12B transmits the recipient input information received in SEQ 502 to the information processing apparatus 10 (SEQ 504). The second open and close control unit 40I of the information processing apparatus 10 receives the recipient input information via the acquisition unit 40A. For example, the second open and close control unit 40I of the information processing apparatus 10 discriminates whether the receiving password included in the recipient input information is registered to the delivery management DB 42D. In a case where there is registration as above, the second open and close control unit 40I judges that the recipient Z being the transmission source of the recipient input information is a proper recipient Z (SEQ 506). Here, it is assumed that the recipient Z is judged to be a proper recipient, and description will continue.

Subsequently, the second open and close control unit 40I of the information processing apparatus 10 transmits a confirmation notification indicating that the recipient Z has been confirmed, to the second accommodating unit 12B (SEQ 508). In response, the communication control unit 46B of the second accommodating unit 12B transmits an inquiry notification to the information processing apparatus 10 (SEQ 510).

Then, the second open and close control unit 40I of the information processing apparatus 10 transmits the second switching instruction to the second accommodating unit 12B (SEQ 512 and SEQ 514). That is, when the package 22 is accommodated in the second accommodating unit 12B installed on the delivery destination side and second open and close control unit 40I has received the recipient input information of the recipient Z of the package 22, the second open and close control unit 40I transmits a second switching instruction to the second accommodating unit 12B.

At this time, the second open and close control unit 40I reads the second accommodating unit information corresponding to the receiving password included in the recipient input information received in SEQ 504 from the delivery management DB 42D, and transmits the second switching instruction including the room ID included in the second accommodating unit information, to the second accommodating unit 12B. At this time, the second open and close control unit 40I is only required to transmit the second switching instruction to the second accommodating unit 12B identified by the accommodating unit ID included in the second accommodating unit information.

Having received the second switching instruction from the information processing apparatus 10 via the acquisition unit 46A, the open and close control unit 46C of the second accommodating unit 12B switches the outer door 24 of the room R identified by the room ID included in the second switching instruction, from the locked state to the unlocked state (SEQ 516).

The communication control unit 46B of the second accommodating unit 12B transmits an unlock instruction to the box 20 in the room R (SEQ 518). Having received the unlock instruction, the control unit 20H of the box 20 controls the lock and unlock unit 20J to unlock the lid 20A (SEQ 520).

The recipient Z opens the outer door 24 of the second accommodating unit 12B unlocked by the process of SEQ 516, and receives the package 22 from inside the box 20, which is placed in the room R and is unlocked by the process of SEQ 520 (SEQ 522). Following this, the recipient Z closes the outer door 24.

The communication control unit 46B of the second accommodating unit 12B transmits a receipt notification indicating the completion of receipt of the package 22 to the information processing apparatus 10 (SEQ 524). The transmission control unit 40G of the information processing apparatus 10 transmits the receipt notification to the requester terminal device 14Y (SEQ 526).

Furthermore, the transmission control unit 40G of the information processing apparatus 10 transmits the receipt notification to the recipient terminal device 14Z (SEQ 528). Subsequently, the information processing apparatus 10 executes a logout process of logging the recipient Z of the recipient terminal device 14Z out from the information processing system 1 via the second accommodating unit 12B (SEQ 530 and SEQ 532).

With execution of the receiving process illustrated in FIG. 10, the package 22 accommodated in the second accommodating unit 12B from the inside of the usable area P by the person-in-charge X1 can be received from the outside of the usable area P by the recipient Z through the outer door 24.

As described above, the information processing apparatus 10 of the present embodiment includes the selection unit 40D, the first open and close control unit 40H, and the second open and close control unit 40I. The selection unit 40D selects at least one of the plurality of delivery persons X as the person-in-charge X1 of the package 22 based on the delivery destination information regarding the delivery destination of the package 22 and the delivery person management information of the plurality of delivery persons X. Having received the delivery person input information of the person-in-charge X1, the first open and close control unit 40H transmits the first switching instruction for switching the door 25 of the first accommodating unit 12A installed on the delivery source side and accommodating the package 22 from the locked state to the unlocked state, to the first accommodating unit 12A. That is, when the package 22 is accommodated in the second accommodating unit 12B installed on the delivery destination side and second open and close control unit 40I has received the recipient input information of the recipient Z of the package 22, the second open and close control unit 40I transmits the second switching instruction of switching the door 25 of the second accommodating unit 12B from the locked state to the unlocked state, to the second accommodating unit 12B.

Here, in order to ensure the security of the package 22 to be delivered, a limited delivery person with fidelity guarantee has been in charge of delivery in conventional operations. For this reason, there have been cases where it is difficult to obtain an appropriate delivery person for delivering the package 22, leading to inefficient delivery.

In contrast, in the information processing apparatus 10 of the present embodiment, the selection unit 40D selects at least one of the plurality of delivery persons X as the person-in-charge X1 of the package 22 based on the delivery destination information and the delivery person management information. This enables the information processing apparatus 10 to select a certain person-in-charge X1 as the person-in-charge X1 who delivers the package 22. With this configuration, the information processing apparatus 10 of the present embodiment can improve the efficiency of delivery of the package 22.

Furthermore, in the information processing apparatus 10 of the present embodiment, when the first open and close control unit 40H has received the delivery person input information of the person-in-charge X1, the first open and close control unit 40H transmits the first switching instruction to the first accommodating unit 12A. Therefore, the door 25 of the first accommodating unit 12A that accommodates the package 22 and installed on the delivery source side of the package 22 is switched from the locked state to the unlocked state when the information processing apparatus 10 receives the delivery person input information of the person-in-charge X1. This makes it possible to suppress delivering the package 22 accommodated in the first accommodating unit 12A to a user U other than the person-in-charge X1.

Furthermore, when the package 22 is accommodated in the second accommodating unit 12B installed on the delivery destination side and second open and close control unit 40I has received the recipient input information of the recipient Z of the package 22, the second open and close control unit 40I transmits a second switching instruction to the second accommodating unit 12B. Therefore, the door 25 of the second accommodating unit 12B accommodating the package 22 delivered by the person-in-charge X1 is switched from the locked state to the unlocked state when the recipient information of the recipient Z of the package 22 is received. This makes it possible to suppress delivering the package 22 accommodated in the second accommodating unit 12B to a user U other than the recipient Z. In addition, the recipient Z can easily receive the package 22 without facing the person-in-charge X1.

Consequently, the information processing apparatus 10 of the present embodiment can achieve both security assurance and delivery efficiency improvement.

In addition, the delivery person management information includes usage information regarding the use of public transportation F by the delivery person X. The public transportation F is usable within a usable area P where public transportation F is usable, for example. The selection unit 40D selects the person-in-charge X1 based on the delivery person management information including the usage information. With this selection, the selection unit 40D will select an appropriate person-in-charge X1 by using the usage information of the public transportation F within the usable area P, which has higher security than the outside of the usable area P.

Consequently, the information processing apparatus 10 of the present embodiment can achieve further higher security assurance in addition to the above effects.

The delivery person management information further includes the current position information of the delivery person X. The selection unit 40D, selects the delivery person X located within a predetermined range from the first accommodating unit 12A as the person-in-charge X1 based on the desired arrival time included in the delivery destination information, the installation location information of the first accommodating unit 12A accommodating the package 22, and the delivery person management information.

That is, the selection unit 40D selects the delivery person X that can arrive earlier at the first accommodating unit 12A as the person-in-charge X1. Therefore, in addition to the above effects, the information processing apparatus 10 of the present embodiment can select a person-in-charge X1 suitable for delivering the package 22 requested by the requester Y.

In addition, the delivery person management information further includes a confidence score indicating the reliability of the delivery person X. The selection unit 40D selects a delivery person X having a confidence score of the requirement score or more, as the person-in-charge X1, based on the requirement score to the person-in-charge X1, the installation location information of the first accommodating unit 12A accommodating the package 22, and the delivery person management information.

That is, the selection unit 40D selects the delivery person X that satisfies the requirement score for the person-in-charge X1 by the requester Y, as the person-in-charge X1. Therefore, in addition to the above effects, the information processing apparatus 10 of the present embodiment can select a person-in-charge X1 suitable for delivering the package 22 requested by the requester Y.

In addition, the package 22 is delivered within the usable area P by the person-in-charge X1 who is permitted to enter the usable area P of the public transportation F. The usable area P is an area where security is ensured as compared with the area outside the usable area P by using a system for managing the public transportation F, or the like. In the present embodiment, the package 22 is delivered within the usable area P by the person-in-charge X1 who is permitted to enter the usable area P.

Consequently, the information processing apparatus 10 of the present embodiment can achieve further higher security assurance regarding the delivery of the package 22 in addition to the above effects.

Furthermore, the first accommodating unit 12A and the second accommodating unit 12B are arranged across the boundary T of the usable area P. With this configuration, the person-in-charge X1 can take out or accommodate the package 22 from the inside of the boundary T of the usable area P in the first accommodating unit 12A and the second accommodating unit 12B. Moreover, the requester Y and the recipient Z can take out or accommodate the package 22 from outside the boundary T of the usable area P. That is, in the present embodiment, the person-in-charge X1 can be determined a user U who can open and close the doors 25 of the first accommodating unit 12A and the second accommodating unit 12B only from the inside of the usable area P.

Consequently, the information processing apparatus 10 of the present embodiment can achieve further higher security assurance regarding the delivery of the package 22 in addition to the above effects.

Furthermore, having received the delivery person input information, the first open and close control unit 40H transmits the first switching instruction for switching the door 25 (inner door 26) that can be opened and closed toward the inside of the usable area P in the first accommodating unit 12A from the locked state to the unlocked state, to the first accommodating unit 12A.

This enables the person-in-charge X1 to take out the package 22 from the inner door 26 in the first accommodating unit 12A. That is, in the present embodiment, the package 22 can be delivered to the person-in-charge X1 within the usable area P. Accordingly, the information processing apparatus 10 of the present embodiment can achieve further higher security assurance regarding the delivery of the package 22 in addition to the above effects.

Moreover, having received the delivery person input information for requesting the delivery of the package 22 from the requester Y, the first open and close control unit 40H transmits the third switching instruction for switching the door 25 (outer door 24) that can be opened and closed toward the outside of the usable area P in the first accommodating unit 12A from the locked state to the unlocked state, to the first accommodating unit 12A.

Therefore, the requester Y can accommodate the package 22 in the first accommodating unit 12A from the outside of the usable area P without entering the usable area P. Therefore, the information processing apparatus 10 of the present embodiment can further improve the efficiency of delivery of the package 22, in addition to the above effects. Furthermore, the requester Y can easily request the delivery of the package 22 without facing the person-in-charge X1.

In addition, having received the recipient input information, the second open and close control unit 40I transmits the second switching instruction for switching the door 25 (outer door 24) that can be opened and closed toward the outside of the usable area P in the second accommodating unit 12B from the locked state to the unlocked state, to the second accommodating unit 12B.

With this configuration, the recipient Z can open the door 25 of the second accommodating unit 12B from the outside of the usable area P and receive the package 22 in the second accommodating unit 12B without entering the usable area P. Therefore, the information processing apparatus 10 of the present embodiment can further improve the efficiency of delivery of the package 22, in addition to the above effects.

In addition, having received the delivery person input information, the second open and close control unit 40I transmits the fourth switching instruction for switching the door 25 (inner door 26) that can be opened and closed toward the inside of the usable area P in the second accommodating unit 12B from the locked state to the unlocked state, to the second accommodating unit 12B.

Accordingly, having arrived at the second accommodating unit 12B on the delivery destination side, the person-in-charge X1 can open the door 25 (inner door 26) of the second accommodating unit 12B from the inside of the usable area P and accommodate the package 22 in the second accommodating unit 12B. That is, the person-in-charge X1 can accommodate the package 22 in the second accommodating unit 12B within the usable area P. Therefore, in addition to the above effects, the information processing apparatus 10 of the present embodiment can further enhance security assurance.

Moreover, the delivery destination information includes at least one piece of information among the delivery destination point of the package 22, the recipient contact information, desired arrival time, and a requirement score to the person-in-charge X1, for example. Therefore, in addition to the above effects, the selection unit 40D can select the person-in-charge X1 suitable for delivering the package 22 with high efficiency.

In addition, the delivery person input information includes the personal information of the person-in-charge X1. Having received the delivery person input information, the first open and close control unit 40H transmits the first switching instruction to the first accommodating unit 12A. Therefore, the information processing apparatus 10 of the present embodiment can suppress transmission of the first switching instruction by the information input by a user U other than the person-in-charge X1. Therefore, in addition to the above effects, the information processing apparatus 10 of the present embodiment can further enhance security assurance.

In addition, the acquisition unit 40A acquires a detection result regarding the person-in-charge X1. The management unit 40E manages the delivery status information of the package 22 based on the detection result. By managing the delivery status information of the package 22, it is possible to manage the information usable for monitoring the delivery status of the package 22. Therefore, in addition to the above effects, the information processing apparatus 10 of the present embodiment can further improve the efficiency of delivery of the package 22 and further enhance security assurance.

In addition, the evaluation unit 40F evaluates the person-in-charge X1 based on the delivery status information. The update unit 40J updates the confidence score indicating the reliability of the person-in-charge X1 based on the evaluation result of the evaluation unit 40F. Accordingly, the selection unit 40D can select the person-in-charge X1 by using the latest confidence score of the delivery person X.

In addition, the calculation unit 40C calculates the delivery fee of the package 22 based on the delivery destination information. The transmission control unit 40G transmits the delivery fee information indicating the delivery fee to the terminal device 14 (requester terminal device 14Y) of the requester Y who requested the delivery of the package 22. Consequently, in addition to the above effects, the information processing apparatus 10 of the present embodiment can easily provide the user U with information regarding the delivery.

Furthermore, in the first accommodating unit 12A and the second accommodating unit 12B, one of the door 25 (inner door 26) that can be opened and closed toward the inside of the usable area P and the door 25 (outer door 24) that can be opened and closed toward the outside of the usable area P, can be switched from the locked state to the unlocked state when the other is in the locked state.

With this configuration, in the present embodiment, it is possible to suppress a situation having a state of failure to lock at least one door 25 of the outer door 24 and the inner door 26 of the accommodating unit 12 (first accommodating unit 12A and second accommodating unit 12B), and the package 22 is taken out from the other door 25 in this state. Therefore, in the present embodiment, in addition to the above effects, it is possible to improve the security at the time of delivery of the package 22 via the accommodating unit 12.

Furthermore, the first accommodating unit 12A and the second accommodating unit 12B accommodate the package 22 contained in the box 20 that can be switched between the locked state and the unlocked state.

This configuration enables the person-in-charge X1 to deliver the box 20. That is, the package 22 is delivered from the delivery source to the delivery destination without being confirmed by the person-in-charge X1. Therefore, in the present embodiment, in addition to the above effects, it is possible to further improve the security of the package 22 at the time of delivery by the person-in-charge X1.

Furthermore, the box 20 accommodated in the first accommodating unit 12A is switched from the locked state to the unlocked state when the first accommodating unit 12A receives the first switching instruction. The box 20 accommodated in the second accommodating unit 12B is switched from the locked state to the unlocked state when the second accommodating unit 12B receives the second switching instruction. This makes it possible to suppress the situation in which the box 20 shift to the unlocked state at the time of delivery by the person-in-charge X1. Therefore, in the present embodiment, in addition to the above effects, it is possible to further improve the security of the package 22 at the time of delivery by the person-in-charge X1.

Furthermore, the information processing system 1 of the present embodiment includes the information processing apparatus 10, the first accommodating unit 12A, and the second accommodating unit 12B. With the presence of the information processing apparatus 10, the information processing system 1 can achieve both security assurance and delivery efficiency improvement.

[Modifications]

The above embodiment is an exemplary case where the accommodating units 12 (first accommodating unit 12A and second accommodating unit 12B) are disposed across the boundary T of the usable area P, and the inner door 26 and the outer door 24 are located across the boundary T.

However, the accommodating units 12 are not limited to the configuration including the inner door 26 that opens and closes toward the inside of the usable area P and the outer door 24 that opens and closes toward the outside of the usable area P. For example, the accommodating unit 12 may include only one of the inner door 26 or the outer door 24. Furthermore, the accommodating units 12 is not limited be disposed across the boundary T of the usable area P. The accommodating unit 12 may have the door 25 provided on one specific surface alone.

In this case, when having received the requester input information of the requester Y, the first open and close control unit 40H is only required to transmit the third switching instruction for switching the door 25 of the room R in which the package 22 is not accommodated, in the first accommodating unit 12A, from the locked state to the unlocked state, to the first accommodating unit 12A.

Furthermore, when having received the delivery person input information of the person-in-charge X1, the first open and close control unit 40H is only required to transmit the first switching instruction for switching the door 25 of the room R identified by the room ID of the first accommodating unit information corresponding to the delivery password included in the delivery person input information in the first accommodating unit 12A from the locked state to the unlocked state, to the first accommodating unit 12A.

Moreover, when having received the delivery person input information of the person-in-charge X1, the second open and close control unit 40I is only required to transmit the fourth switching instruction for switching the door 25 of the room R in which the package 22 is not accommodated, in the second accommodating unit 12B from the locked state to the unlocked state, to the second accommodating unit 12B.

Furthermore, when having received the recipient input information of the recipient Z, the second open and close control unit 40I is only required to transmit the second switching instruction for switching the door 25 of the room R identified by the room ID of the second accommodating unit information corresponding to the receiving password included in the recipient information in the second accommodating unit 12B from the locked state to the unlocked state, to the second accommodating unit 12B.

By using a configuration of the accommodating unit 12 that is not limited to the configuration in which the accommodating units 12 are disposed across the boundary T or the configuration including both the inner door 26 and the outer door 24 in this manner, the information processing system 1 has an advantageous effect of improving the degree of freedom of the installation position of the accommodating unit 12, in addition to the effect of the embodiment described above. This also leads to improvement of the degree of freedom of the delivery route of the package 22.

While the embodiments and modifications of the present disclosure have been described above, the processes related to the above-described embodiments and modifications may be performed in various different forms other than the above-described embodiments and modifications. Furthermore, the above-described embodiments and modifications can be appropriately combined within a range implementable without contradiction of processes.

The effects described in the present specification are merely examples, and thus, there may be other effects, not limited to the exemplified effects.

(Hardware Configuration)

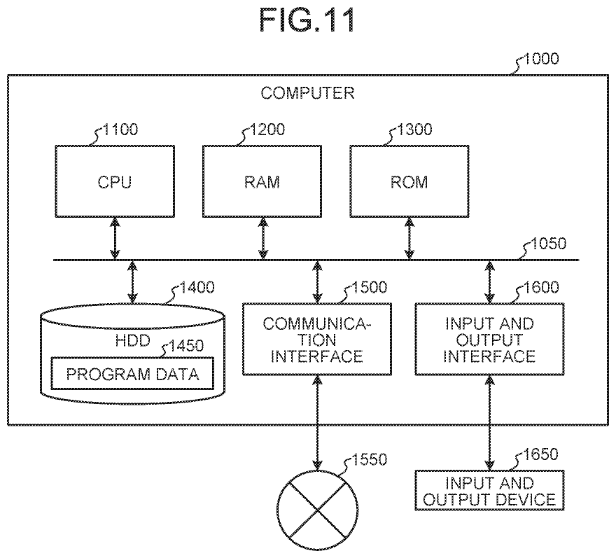

FIG. 11 is a hardware configuration diagram illustrating an example of a computer 1000 that actualizes the functions of the information processing apparatus 10, the accommodating units 12, the terminal device 14, and the box 20 according to the above embodiment and the modifications.

The computer 1000 includes a CPU 1100, RAM 1200, read only memory (ROM) 1300, a hard disk drive (HDD) 1400, a communication interface 1500, and an input and output interface 1600. Each of components of the computer 1000 is interconnected by a bus 1050.

The CPU 1100 operates based on a program stored in the ROM 1300 or the HDD 1400 so as to control each of components. For example, the CPU 1100 develops a program stored in the ROM 1300 or the HDD 1400 into the RAM 1200 and executes processes corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that records a program to be executed by the CPU 1100, data used by the program, or the like. Specifically, the HDD 1400 is a recording medium that records an image processing program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input and output interface 1600 is an interface for connecting between an input and output device 1650 and the computer 1000. For example, the CPU 1100 receives data from an input device such as a keyboard or a mouse via the input and output interface 1600. In addition, the CPU 1100 transmits data to an output device such as a display, a speaker, or a printer via the input and output interface 1600. Furthermore, the input and output interface 1600 may function as a media interface for reading a program or the like recorded on predetermined recording media. Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the information processing apparatus 10 according to the above embodiments, the CPU 1100 of the computer 1000 executes the information processing program loaded on the RAM 1200 to implement the functions of the selection unit 40D or the like. The HDD 1400 stores the program and the data in the storage unit 42 according to the present disclosure. While the CPU 1100 executes the program data 1450 read from the HDD 1400, the CPU 1100 may acquire these programs from another device via the external network 1550, as another example.

Note that the present technology can also have the following configurations.

(1)

An information processing apparatus comprising:

a selection unit that selects at least one of a plurality of delivery persons as a person-in-charge of delivering a package based on delivery destination information regarding a delivery destination of the package and delivery person management information of the plurality of delivery persons;

a first open and close control unit that, after having received delivery person input information of the person-in-charge, transmits a first switching instruction for switching a door of a first accommodating unit installed on a delivery source side and accommodating the package, from a locked state to an unlocked state, to the first accommodating unit; and

a second open and close control unit that, after the package is accommodated in a second accommodating unit installed on a delivery destination side and after having received recipient input information of a recipient of the package, transmits a second switching instruction for switching

a door of the second accommodating unit from a locked state to an unlocked state, to the second accommodating unit.

(2)

The information processing apparatus according to (1),

wherein the delivery person management information

includes usage information regarding use of public transportation by the delivery person.

(3)

The information processing apparatus according to (2),

wherein the delivery person management information further includes

current position information of the delivery person, and

the selection unit

selects the delivery person located within a predetermined range from the first accommodating unit, as the person-in-charge, based on a desired arrival time included in the delivery destination information, installation location information of the first accommodating unit that accommodates the package, and the delivery person management information.

(4)

The information processing apparatus according to (2),

wherein the delivery person management information further includes

current position information of the delivery person, and a confidence score indicating reliability of the delivery person, and

the selection unit

selects the delivery person located within a predetermined range from the first accommodating unit and having the confidence score being a requirement score or more, as the person-in-charge, based on a desired arrival time and the requirement score included in the delivery destination information, installation location information of the first accommodating unit that accommodates the package, and the delivery person management information.

(5)

The information processing apparatus according to (2),

wherein the package is

delivered within an usable area of public transportation by the person-in-charge authorized to enter the usable area.

(6)

The information processing apparatus according to (5),

wherein the first accommodating unit and the second accommodating unit are disposed across a boundary of the usable area.

(7)

The information processing apparatus according to (5) or (6) ,

wherein, after having received the delivery person input information, the first open and close control unit

transmits the first switching instruction for switching a door that can be opened and closed toward inside of the usable area in the first accommodating unit, from the locked state to the unlocked state, to the first accommodating unit.

(8)

The information processing apparatus according to any one of (5) to (7),

wherein, after having received requester input information of a requester who requests delivery of the package, the first open and close control unit

transmits a third switching instruction for switching a door that can be opened and closed toward outside of the usable area in the first accommodating unit from the locked state to the unlocked state, to the first accommodating unit.

(9)

The information processing apparatus according to any one of (5) to (8),

wherein, after having received the recipient input information, the second open and close control unit

transmits the second switching instruction for switching a door that can be opened and closed toward outside of the usable area in the second accommodating unit from the locked state to the unlocked state, to the second accommodating unit.

(10)

The information processing apparatus according to any one of (5) to (9),

wherein, after having received the delivery person input information, the second open and close control unit

transmits a fourth switching instruction for switching a door that can be opened and closed toward inside of the usable area in the second accommodating unit from the locked state to the unlocked state, to the second accommodating unit.

(11)

The information processing apparatus according to any one of (1) to (10),

wherein the delivery destination information

includes at least one piece of information including: a delivery destination point of the package, recipient's contact information, desired arrival time, and a requirement score for the person-in-charge.

(12)

The information processing apparatus according to any one of (1) to (11),

wherein the delivery person input information

includes personal information of the person-in-charge.

(13)

The information processing apparatus according to any one of (1) to (12), further comprising:

an acquisition unit that acquires a detection result of the person-in-charge; and

a management unit that manages delivery status information of the package based on the detection result. (14)

The information processing apparatus according to (13), further comprising:

an evaluation unit that evaluates the person-in-charge based on the delivery status information; and

an update unit that updates a confidence score indicating reliability of the person-in-charge based on the evaluation result of the evaluation unit.

(15)

The information processing apparatus according to any one of (1) to (14), further comprising:

a calculation unit that calculates a delivery fee of the package based on the delivery destination information; and

a transmission control unit that transmits delivery fee information indicating the delivery fee to a terminal device of a requester who has requested the delivery of the package.

(16)

The information processing apparatus according to any one of (1) to (15),

wherein, in the first accommodating unit and the second accommodating unit, one of a door that can be opened and closed toward an inside of a usable area of public transportation or a door that can be opened and closed toward an outside of the usable area can be switched from the locked state to the unlocked state when the other door is in the locked state.

(17)

The information processing apparatus according to any one of (1) to (16),

wherein the first accommodating unit and the second accommodating unit

accommodate the package contained in a box that can be switched between a locked state and an unlocked state.

(18)

The information processing apparatus according to (17),

wherein the box accommodated in the first accommodating unit is switched from the locked state to the unlocked state when the first accommodating unit has received the first switching instruction, and

the box accommodated in the second accommodating unit is switched from the locked state to the unlocked state when the second accommodating unit has received the second switching instruction.

(19)

An information processing method executed by a computer, the method including:

selecting at least one of a plurality of delivery persons as a person-in-charge of delivering a package based on delivery destination information regarding a delivery destination of the package and delivery person management information of the plurality of delivery persons;

transmitting a delivery request information corresponding to the delivery destination information to a terminal device of the person-in-charge;

transmitting, after having received delivery person input information of the person-in-charge, a first switching instruction for switching a door of a first accommodating unit installed on a delivery source side and accommodating the package, from a locked state to an unlocked state, to the first accommodating unit; and

transmitting, after the package is accommodated in a second accommodating unit installed on a delivery destination side and after having received recipient input information of a recipient of the package, a second switching instruction for switching a door of the second accommodating unit from a locked state to an unlocked state, to the second accommodating unit.

(20)

An information processing system including: an information processing apparatus; a first accommodating unit that communicates with the information processing apparatus; and a second accommodating unit that communicates with the information processing apparatus,

in which the information processing apparatus includes:

a selection unit that selects at least one of a plurality of delivery persons as a person-in-charge of delivering a package based on delivery destination information regarding a delivery destination of the package and delivery person management information of the plurality of delivery persons;

a transmission control unit that transmits delivery request information corresponding to the delivery destination information to a terminal device of the person-in-charge;

a first open and close control unit that, after having received delivery person input information of the person-in-charge, transmits a first switching instruction for switching a door of a first accommodating unit installed on a delivery source side and accommodating the package, from a locked state to an unlocked state, to the first accommodating unit; and

a second open and close control unit that, after the package is accommodated in a second accommodating unit installed on a delivery destination side and after having received recipient input information of a recipient of the package, transmits a second switching instruction for switching a door of the second accommodating unit from a locked state to an unlocked state, to the second accommodating unit.

### REFERENCE SIGNS LIST

1 INFORMATION PROCESSING SYSTEM

10 INFORMATION PROCESSING APPARATUS

12A FIRST ACCOMMODATING UNIT

12B SECOND ACCOMMODATING UNIT

40A ACQUISITION UNIT

40B REGISTRATION UNIT

40C CALCULATION UNIT

40D SELECTION UNIT

40E MANAGEMENT UNIT

40F EVALUATION UNIT

40G TRANSMISSION CONTROL UNIT

40H FIRST OPEN AND CLOSE CONTROL UNIT

40I SECOND OPEN AND CLOSE CONTROL UNIT

40J UPDATE UNIT

1. An information processing apparatus comprising:
a selection unit that selects at least one of a plurality of delivery persons as a person-in-charge of delivering a package based on delivery destination information regarding a delivery destination of the package and delivery person management information of the plurality of delivery persons;
a first open and close control unit that, after having received delivery person input information of the person-in-charge, transmits a first switching instruction for switching a door of a first accommodating unit installed on a delivery source side and accommodating the package, from a locked state to an unlocked state, to the first accommodating unit; and
a second open and close control unit that, after the package is accommodated in a second accommodating unit installed on a delivery destination side and after having received recipient input information of a recipient of the package, transmits a second switching instruction for switching
a door of the second accommodating unit from a locked state to an unlocked state, to the second accommodating unit.

2. The information processing apparatus according to claim 1,
wherein the delivery person management information
includes usage information regarding use of public transportation by the delivery person.

3. The information processing apparatus according to claim 2,
wherein the delivery person management information further includes
current position information of the delivery person, and the selection unit
selects the delivery person located within a predetermined range from the first accommodating unit, as the person-in-charge, based on a desired arrival time included in the delivery destination information, installation location information of the first accommodating unit that accommodates the package, and the delivery person management information.

4. The information processing apparatus according to claim 2,
wherein the delivery person management information further includes
current position information of the delivery person, and a confidence score indicating reliability of the delivery person, and
the selection unit
selects the delivery person located within a predetermined range from the first accommodating unit and having the confidence score being a requirement score or more, as the person-in-charge, based on a desired arrival time and the requirement score included in the delivery destination information, installation location information of the first accommodating unit that accommodates the package, and the delivery person management information.

5. The information processing apparatus according to claim 2,
wherein the package is
delivered within an usable area of public transportation by the person-in-charge authorized to enter the usable area.

6. The information processing apparatus according to claim 5,
wherein the first accommodating unit and the second accommodating unit are disposed across a boundary of the usable area.

7. The information processing apparatus according to claim 5,
wherein, after having received the delivery person input information, the first open and close control unit
transmits the first switching instruction for switching a door that can be opened and closed toward inside of the usable area in the first accommodating unit, from the locked state to the unlocked state, to the first accommodating unit.

8. The information processing apparatus according to claim 5,
wherein, after having received requester input information of a requester who requests delivery of the package, the first open and close control unit
transmits a third switching instruction for switching a door that can be opened and closed toward outside of the usable area in the first accommodating unit from the locked state to the unlocked state, to the first accommodating unit.

9. The information processing apparatus according to claim 5,
wherein, after having received the recipient input information, the second open and close control unit
transmits the second switching instruction for switching a door that can be opened and closed toward outside of the usable area in the second accommodating unit from the locked state to the unlocked state, to the second accommodating unit.

10. The information processing apparatus according to claim 5,
wherein, after having received the delivery person input information, the second open and close control unit
transmits a fourth switching instruction for switching a door that can be opened and closed toward inside of the usable area in the second accommodating unit from the locked state to the unlocked state, to the second accommodating unit.

11. The information processing apparatus according to claim 1,
wherein the delivery destination information
includes at least one piece of information including: a delivery destination point of the package, recipient's contact information, desired arrival time, and a requirement score for the person-in-charge.

12. The information processing apparatus according to claim 1,
wherein the delivery person input information
includes personal information of the person-in-charge.

13. The information processing apparatus according to claim 1, further comprising:
an acquisition unit that acquires a detection result of the person-in-charge; and
a management unit that manages delivery status information of the package based on the detection result.

14. The information processing apparatus according to claim 13, further comprising:
an evaluation unit that evaluates the person-in-charge based on the delivery status information; and
an update unit that updates a confidence score indicating reliability of the person-in-charge based on the evaluation result of the evaluation unit.

15. The information processing apparatus according to claim 1, further comprising:
a calculation unit that calculates a delivery fee of the package based on the delivery destination information; and
a transmission control unit that transmits delivery fee information indicating the delivery fee to a terminal device of a requester who has requested the delivery of the package.

16. The information processing apparatus according to claim 1,
wherein, in the first accommodating unit and the second accommodating unit, one of a door that can be opened and closed toward an inside of a usable area of public transportation or a door that can be opened and closed toward an outside of the usable area can be switched from the locked state to the unlocked state when the other door is in the locked state.

17. The information processing apparatus according to claim 1,
wherein the first accommodating unit and the second accommodating unit
accommodate the package contained in a box that can be switched between a locked state and an unlocked state.

18. The information processing apparatus according to claim 17,
wherein the box accommodated in the first accommodating unit is switched from the locked state to the unlocked state when the first accommodating unit has received the first switching instruction, and
the box accommodated in the second accommodating unit is switched from the locked state to the unlocked state when the second accommodating unit has received the second switching instruction.

19. An information processing method executed by a computer, the method comprising:
selecting at least one of a plurality of delivery persons as a person-in-charge of delivery of a package based on delivery destination information regarding a delivery destination of the package and delivery person management information of the plurality of delivery persons;
transmitting, after having received delivery person input information of the person-in-charge, a first switching instruction for switching a door of a first accommodating unit installed on a delivery source side and accommodating the package, from a locked state to an unlocked state, to the first accommodating unit; and
transmitting, after the package is accommodated in a second accommodating unit installed on a delivery destination side and after having received recipient input information of a recipient of the package, a second switching instruction for switching a door of the second accommodating unit from a locked state to an unlocked state, to the second accommodating unit.

20. An information processing system comprising: an information processing apparatus; a first accommodating unit that communicates with the information processing apparatus; and a second accommodating unit that communicates with the information processing apparatus,
wherein the information processing apparatus includes:
a selection unit that selects at least one of a plurality of delivery persons as a person-in-charge of delivering a package based on delivery destination information regarding a delivery destination of the package and delivery person management information of the plurality of delivery persons;
a first open and close control unit that, after having received delivery person input information of the person-in-charge, transmits a first switching instruction for switching a door of a first accommodating unit installed on a delivery source side and accommodating the package, from a locked state to an unlocked state, to the first accommodating unit; and
a second open and close control unit that, after the package is accommodated in a second accommodating unit installed on a delivery destination side and after having received recipient input information of a recipient of the package, transmits a second switching instruction for switching a door of the second accommodating unit from a locked state to an unlocked state, to the second accommodating unit.
